(19) United States
(12) Patent Application Publication
(10) Pub. No.: US 2026/0093977 A1
(43) Pub. Date: Apr. 2, 2026

(54) Machine Learning Systems and Methods for Real Time Anomaly Detection and Prescriptive Feedback

(71) Applicant: Zebra Technologies Corporation, Lincolnshire, IL (US)

(72) Inventors: Caleb Popow, Hampstead, MD (US); Ross Caisse, Walpole, MA (US); Aner Gabay, Shrewsbury, MA (US); Shreenivasa A. Desai, Bangalore (IN); Gowtham Balan, Bangalore (IN); Robert T. Donald, Nashua, NH (US); Ashwini Ardikoppa Shashidhara, Bangalore (IN); Vinay Kumar, Mysore (IN); Zion Orent, Cambridge, MA (US); Aman Kumar, Bangalore (IN)

(73) Assignee: Zebra Technologies Corporation, Lincolnshire, IL (US)

(21) Appl. No.: 18/943,495

(22) Filed: Nov. 11, 2024

Related U.S. Application Data
(60) Provisional application No. 63/701,504, filed on Sep. 30, 2024.

(51) Int. Cl. G06N 3/08; G06N 3/0455

(52) U.S. Cl. CPC G06N 3/08; G06N 3/0455

(57) ABSTRACT

A method for anomaly detection comprising receiving data parameters defining a first query; retrieving a first dataset corresponding to the data parameters; receiving second data parameters defining a second query linked to the first query; selecting a predefined filter; retrieving a second dataset based on the first dataset, the predefined filter, and the second data parameters; analyzing, using a machine learning model trained in real-time, the second dataset to detect anomalies; selecting anomaly parameters corresponding to the anomalies; filtering an output of the machine learning model according to the anomaly parameters; generating instructions for identifying anomalous items based on the data parameters, the predefined filter, the second data parameters, the anomaly parameters, and detection pattern parameters; executing the set of instructions for identifying anomalous items to identify anomalous items in real-time within the second dataset; and transmitting information about the anomalous items to a computing device.

### CROSS-REFERENCE TO RELATED APPLICATIONS

This application claims priority to U.S. Provisional Application No. 63/701,504, filed Sep. 30, 2024, which is incorporated herein by reference in its entirety.

### TECHNICAL FIELD

The present disclosure is generally directed to methods and systems for using machine learning models for real-time anomaly detection, generating a pattern for continuous monitoring of data, and assigning prescriptive actions in response to detecting anomalies.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Existing anomaly detection processes, such as those in the retail exception-based reporting, lack the ability to create new data and detect anomalies in an on-demand, real-time manner. Additionally, existing anomaly detection processes do not include converting anomaly detection into a repeated and persistent process, providing prescriptive actions for correcting the anomaly to select users based on a level of responsibility and/or security, and communicating prescriptive actions with external task management applications. Furthermore, existing anomaly detection processes cannot easily operate on multi-step, multi-source queries to solve multi-step problems. Thus, there exists an opportunity for on-demand, real-time anomaly detection for multiple queries linked queries.

### BRIEF SUMMARY

In an implementation, a method for anomaly detection, the method comprising: receiving, via one or more processors, a set of data parameters defining a first query; retrieving, via the one or more processors, a first dataset corresponding to the set of data parameters from a database; receiving, via the one or more processors, a second set of data parameters defining a second query linked to the first query; selecting, via the one or more processors, a predefined filter; retrieving, via the one or more processors, a second dataset based on the first dataset, the predefined filter, and the second set of data parameters corresponding to the second query linked to the first query; analyzing, via the one or more processors and using a machine learning model trained in real-time, the second dataset to detect one or more anomalies in the dataset; selecting, via the one or more processors, a set of anomaly parameters corresponding to the detected one or more anomalies; filtering, via the one or more processors, an output of the machine learning model according to the set of anomaly parameters; generating, via the one or more processors, a set of instructions for identifying one or more anomalous items based on the set of data parameters, the predefined filter, the second set of data parameters, the set of anomaly parameters, and a set of detection pattern parameters; executing, via the one or more processors, the set of instructions for identifying anomalous items to identify one or more anomalous items in real-time within the second dataset responsive to updates to the second dataset; and transmitting, via the one or more processors, information about the one or more anomalous items to a user computing device or another computing device.

In one implementation, a system for anomaly detection, the system comprising one or more processors, and one or more memories having stored thereon computer-executable instructions that, when executed by the one or more processors, cause the computing system to: receive a set of data parameters defining a first query; retrieve a first dataset corresponding to the set of data parameters from a database; receive a second set of data parameters defining a second query linked to the first query; select a predefined filter; retrieve a second dataset based on the first dataset, the predefined filter, and the second set of data parameters corresponding to the second query linked to the first query; analyze, using a machine learning model trained in real-time, the second dataset to detect one or more anomalies in the dataset; select a set of anomaly parameters corresponding to the detected one or more anomalies; filter an output of the machine learning model according to the set of anomaly parameters; generate a set of instructions for identifying one or more anomalous items based on the set of data parameters, the predefined filter, the second set of data parameters, the set of anomaly parameters, and a set of detection pattern parameters; execute the set of instructions for identifying anomalous items to identify one or more anomalous items in real-time within the second dataset responsive to updates to the second dataset; and transmit information about the one or more anomalous items to a user computing device or another computing device.

### BRIEF DESCRIPTION OF THE FIGURES

The figures described below depict various implementations of the system and methods disclosed therein. It should be understood that each figure depicts one implementation of a particular implementation of the disclosed system and methods, and that each of the figures is intended to accord with a possible implementation thereof. Further, wherever possible, the following description refers to the reference numerals included in the following figures, in which features depicted in multiple figures are designated with consistent reference numerals.

The figures depict preferred implementations for purposes of illustration only. One skilled in the art will readily recognize from the following discussion that alternative implementations of the systems and methods illustrated herein may be employed without departing from the principles of the invention described herein.

FIG. 1 depicts a flow diagram of an exemplary method for real time anomaly detection and prescriptive feedback using machine learning, according to some aspects.

FIG. 2 depicts an example process of selecting a set of data parameters and retrieving data from a database according to the selected set of data parameters, according to some aspects.

FIG. 3 is a diagram illustrating the selection of a set of data parameters and the retrieval of data from a database according to the selected set of data parameters, according to some aspects.

FIG. 4 depicts an example of creating and linking queries in a user interface (UI), according to some aspects.

FIG. 5 depicts an example combined block and flow diagram for creating and linking queries in a UI, according to some aspects.

FIG. 6 depicts an example sequence diagram for rendering the UI, according to some aspects.

FIG. 7 depicts an example sequence diagram for creating and linking queries in the UI, according to some aspects.

FIG. 8 depicts an example flow diagram for linking queries, validating the linked queries, and retrieving data according to some aspects.

FIG. 9 depicts a diagram of a system anomaly detection for multiple linked queries, according to some aspects.

FIG. 10 depicts an example UI with example predefined filters, according to some aspects.

FIG. 11 depicts an example sequence diagram for linking queries, validating the linked queries, and retrieving data, according to some aspects.

FIG. 12 depicts an example of multiple linked queries, according to some aspects.

FIGS. 13A-13B depict an example process of anomaly detection, according to some aspects.

FIGS. 14A-14B depict an example of filtering of the results of the anomaly detection process and the reasons for the anomaly, according to some aspects.

FIG. 15 depicts an example user interface for generating a set of instructions for identifying anomalous items and prescriptive actions responsive to updates to the dataset, according to some aspects.

FIG. 16 depicts a user interface of a transmitted caught item and prescriptive actions to the appropriate user for handling the actions, according to some aspects.

FIG. 17 depicts a sequence diagram illustrating an example of executing a set of instructions for identifying anomalous items in real-time, according to some aspects.

FIGS. 18A-18B depict an example of communicating prescriptive actions to an external task management system, according to some aspects.

FIG. 19 depicts an exemplary computing environment in which the techniques disclosed herein may be implemented, according to some aspects.

FIG. 20 depicts an example of validation errors, according to some aspects.

FIG. 21 depicts an example of query validation, according to some aspects.

### DETAILED DESCRIPTION

### Overview

The present techniques provide systems and methods using machine learning for, inter alia, on-demand, real-time anomaly detection. The methods and systems include, for example, receiving a set of data parameters defining a first query; retrieving a first dataset corresponding to the set of data parameters from a database; receiving a second set of data parameters defining a second query linked to the first query; selecting a predefined filter; retrieving a second dataset based on the first dataset, the predefined filter, and the second set of data parameters corresponding to the second query linked to the first query; analyzing, using a machine learning model trained in real-time, the second dataset to detect one or more anomalies in the dataset; selecting a set of anomaly parameters corresponding to the detected one or more anomalies; filtering an output of the machine learning model according to the set of anomaly parameters; generating a set of instructions for identifying one or more anomalous items based on the set of data parameters, the predefined filter, the second set of data parameters, the set of anomaly parameters, and a set of detection pattern parameters; executing the set of instructions for identifying anomalous items to identify one or more anomalous items in real-time within the second dataset responsive to updates to the second dataset; and transmitting information about the one or more anomalous items to a user computing device or another computing device.

As noted above, existing anomaly detection processes, such as those in the retail exception-based reporting, lack the ability to create new data and detect anomalies in a real-time, on-demand manner. Existing anomaly detection processes do not convert anomaly detection into a repeated and persistent process. Such limitations result in part from technical hurdles facing system providers, as well as retail customers. A particular customer may have tens, hundreds, or thousands of stores, kiosks, warehouses, distribution centers, etc. that each capture data on items, customers, and/or employees. Trying to detect anomalies in the captured data is challenging given the amount of data, the complexity of the captured data, the varying times at which the data is collected, and other factors. These technical hurdles are thus partly a result of data volume.

Yet anomaly detection, especially in areas such as retail exception-based monitoring, has a specificity hurdle. Anomaly detection systems are not capable of detecting new, previously unknown anomalies. A customer may design an executable script highly specified to detect a particular type of anomaly, but identifying anomalies in a trainable manner is not available. If an anomaly is not pre-scripted, it will likely go undetected, as a result. This failure is a particular problem for retailers facing employee theft, where unscrupulous employees continue to develop increasingly sophisticated ways of using the retailer's own computing systems to engage in undetected product theft. System designers also realize that it is exceedingly challenging to create highly-specified anomaly detection scripts and deploy them across remote locations, such as, across an entire region of retail store locations. The more specific the anomaly to be detected, the more challenging it would be to tailor that script to another location or another anomaly detection. Further, the more specific and the more localized an anomaly detection is configured, the more challenging it is to determine prescriptive action and prescribe a suitable response, especially in an on-demand manner based on real time data collection. It is all but impossible, with conventional systems, to have an on-demand, real-time anomaly detection system that can aggregate data across multiple remote locations and determine a response level for prescriptive actions, where that response level can vary from an action at a specific data entry point, such as a particular scan station in a retail location or warehouse, to actions that require supervisory level actions such as continual monitoring of an employee across different locations or across different time windows.

Furthermore, current anomaly detection processes lack the ability to detect anomalies for multi-step, multi-source queries (i.e., linked queries). Some queries involve multiple dependencies on the results of other queries and/or from multiple sources. Currently, systems cannot easily link the different dependencies in a multi-step query. To handle such multi-step, multi-source queries, each multi-step, multi-source query must be hard-coded, leading to inefficiencies due to additional code written for each multi-step, multi-source query. Furthermore, linking queries may present difficulties as some queries may not be able to be linked together. For example, an additional query may be invalid if it does not include any of the same dimensions as a first query to which the additional query is linked.

To overcome these technical hurdles, the present application describes systems and methods that provide on-demand, real-time anomaly detection through a machine learning model that is trained in real-time on collected data. The result is a real-time trainable anomaly detection engine. The collected data may be from one or more locations, such as remote computing systems communicating real-time data to a server, a centralized computing system, etc. having stored therein the anomaly detection engine for performing methods described herein. In various examples, the machine learning model may be an auto encoder neural network, although other example machine learning models include linear or logistic regression, instance-based algorithms, regularization algorithms, decision trees, isolation forest, Bayesian networks, cluster analysis, association rule learning, artificial neural networks, deep learning, combined learning, reinforced learning, dimensionality reduction, and support vector machines, by way of example. In such examples, the machine learning model has an architecture that is not required to be pre-trained while it is still designed for anomaly detection of real-time data. Responsive to the real-time data, anomaly detection parameters may be deployed that filter the real-time data prior to submission to the anomaly detection engine. The real-time data and the anomaly detection engine output may be deployed as a continuous detection pattern that autonomously examines for anomalies in further received real-time data. That is, the anomaly detection engine may be used to generate anomaly patterns that are monitored for. These anomaly patterns may be remote location specific, for example, where the anomaly detection engine detects possible anomalies at a particular location. These anomaly patterns may encompass a multitude of remote locations. These anomaly patterns may be location specific, item specific, item type specific, employee specific, customer specific, etc. or any combinations thereof.

Thus, the techniques of the present disclosure provide a technical improvement over conventional techniques at least by improving the functionality of a computing device (e.g., server executing machine learning model). In particular, the computing device is responsive to multi-step, multi-source queries by allowing the linking of queries and analyzes data resulting from the linked queries using a ML model trained in real-time, generates sets of instructions to identify anomalous items, and executes the instructions in a particular way that enhances the efficiency of the computing device. The computing device is also able to validate linking of the queries to ensure that all queries are properly linked, resulting in increased accuracy of the resulting dataset. Performing these actions enables detection of previously unknown anomalies (i.e., unique anomalies that that a conventional system may not be able to detect) with an efficiency (i.e., in real-time) not achieved using conventional techniques. Additionally, performing these actions enables analysis of multiple linked queries with an efficiency (i.e., reduced code) and accuracy (i.e., ensuring that the queries are properly linked) not achieved using conventional techniques. That is, the present disclosure describes improvements in the functioning of the computer itself because the computing device more efficiently analyzes multi-step, multi-source queries and identifies anomalies as a direct result of being able to handle linked queries (including checking the validity of linking the queries), the machine learning model and the generated sets of instructions. This improves over the prior art at least because existing systems are incapable of handling multi-step, multi-source queries, identifying previously unknown data anomalies in real-time and/or are otherwise unable to analyze data with the efficiency resulting from the disclosed machine learning model and generated sets of instructions.

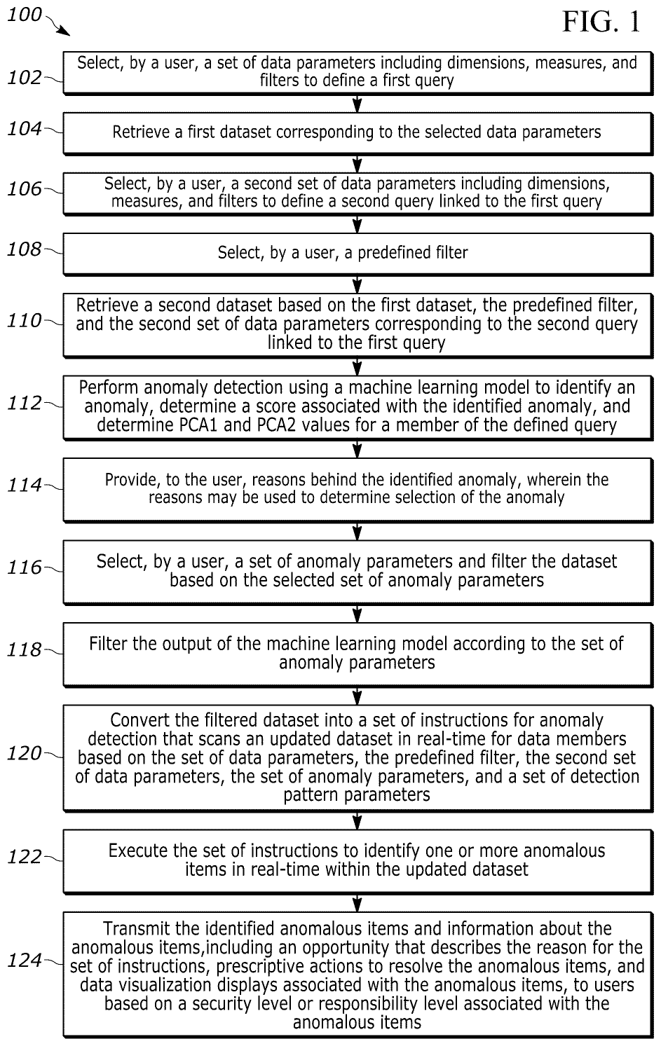

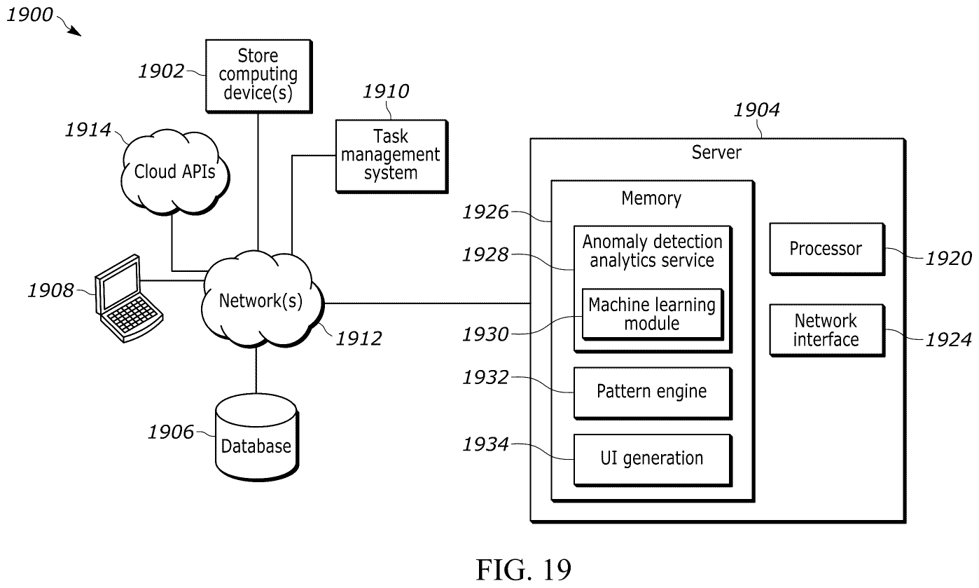

FIG. 1 is a flow diagram of a method for on-demand, real-time anomaly detection with linked queries. In various examples, the methods herein may be implemented through the computing environment depicted in FIG. 19, which may include computing resources for training and/or operating machine learning models to detect anomalies. The environment may include a user device, store computing devices, task management system, server, database, and/or cloud APIs communicatively coupled via a network. A user can access an application for anomaly detection by using a desktop browser or mobile browser via a user device such as the user device 1908 of FIG. 19 below.

The method begins at block 102 with a user, for example, interfacing with a user device such as the device 1908 of FIG. 19, which may be a smart phone, tablet, desktop computer, etc., to select a set of data parameters to define a first query which indicates data the system intends to analyze.

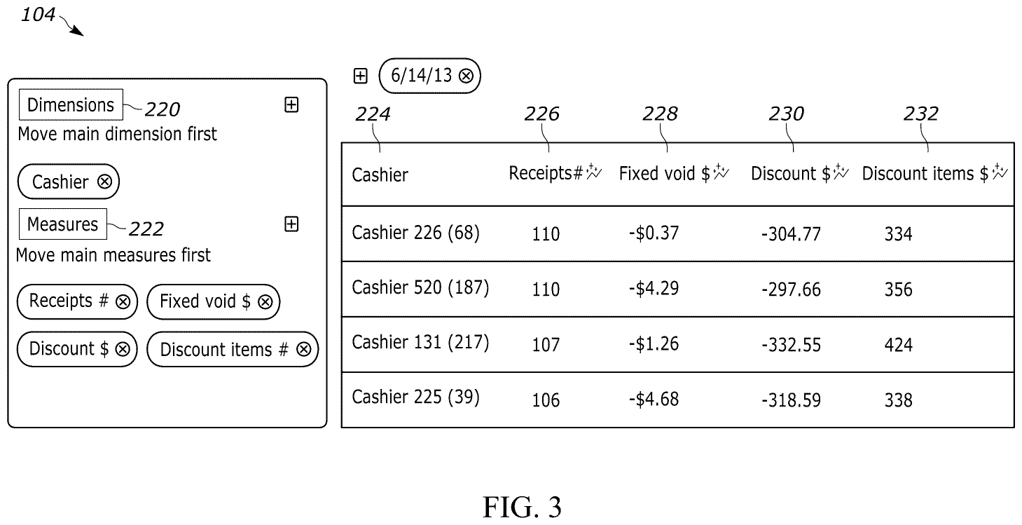

The set of data parameters define a first query and may include dimensions and measures. A dimension is the entity the system intends to analyze and the measures are metrics the system intends to analyze associated with the dimension. The entity may be any entity identifiable in a remote location, including, but not limited to a data collection device, system, station, or any entity associated with or operating a data collection device, system, or station at the remote location. For example, as shown in FIG. 3, a dimension may be one or more cashiers and the measures may be the number of receipts produced by cashiers, a dollar amount of discounts applied by cashiers, a number of items discounted by cashiers, and a fixed void dollar amount for the cashiers. In another example, a dimension may be a store, and measures may include a dollar amount of a suspended transaction and a dollar amount of sales for a particular item. The data parameters may be used to construct a query to submit to a database to retrieve data.

At block 104, a dataset may be retrieved from a database according to the first set of data parameters by submitting the constructed query to the database. The database may be a cloud database such as Google BigQuery.

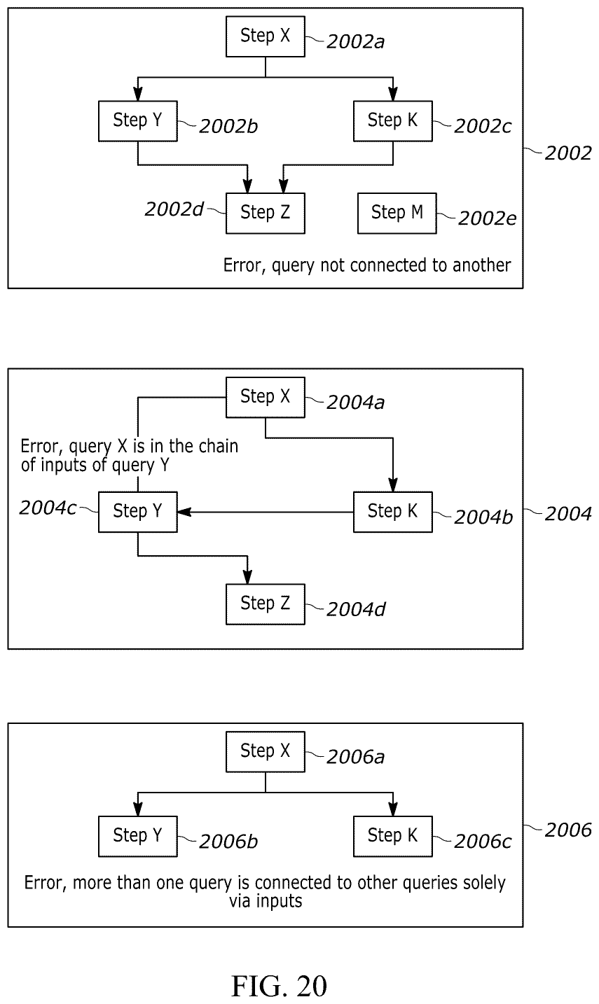

At block 106, a user may navigate to an application page with the user interface to select a second set of data parameters to define another query. A user may define an independent query or may define a second query that will link to the first query. The results of the second query may depend or be based at least in part on the results of the first query. For example, the results of the first query may be passed into the second query. A user may interact with the user interface to link multiple queries from multiple data sources together to form a query tree. For example, a second query may be linked to a first query. In some embodiments, the links between queries are validated. For example, the linked queries may be validated to ensure there are no unconnected queries, no circular dependencies, and no multiple final queries, as described further below in FIG. 20.

At block 108, the user may select a predetermined filter indicating the behavior between the first query and the second query. For example, the second query may use, be based on, and/or accept as an input all of a first dataset corresponding to the first query, specific datapoints from the first dataset corresponding to the first query, or exclude datapoints of the first dataset corresponding to the first query. In some embodiments, the predetermined filter may indicate a time parameter (e.g., window functionality). For example, the second dataset resulting from the second query may include events that occurred within a timeframe (e.g., within a specified number of seconds, minutes, and/or hours), or an event that occurred as the next transaction.

At block 110, the results of the second query (e.g., the second dataset) may be generated and/or displayed, i.e., a second dataset may be retrieved based on the first dataset, the predefined filter, and the second data set of data parameters corresponding to the second query linked to the first query. A user may trigger anomaly detection on the results of the second query.

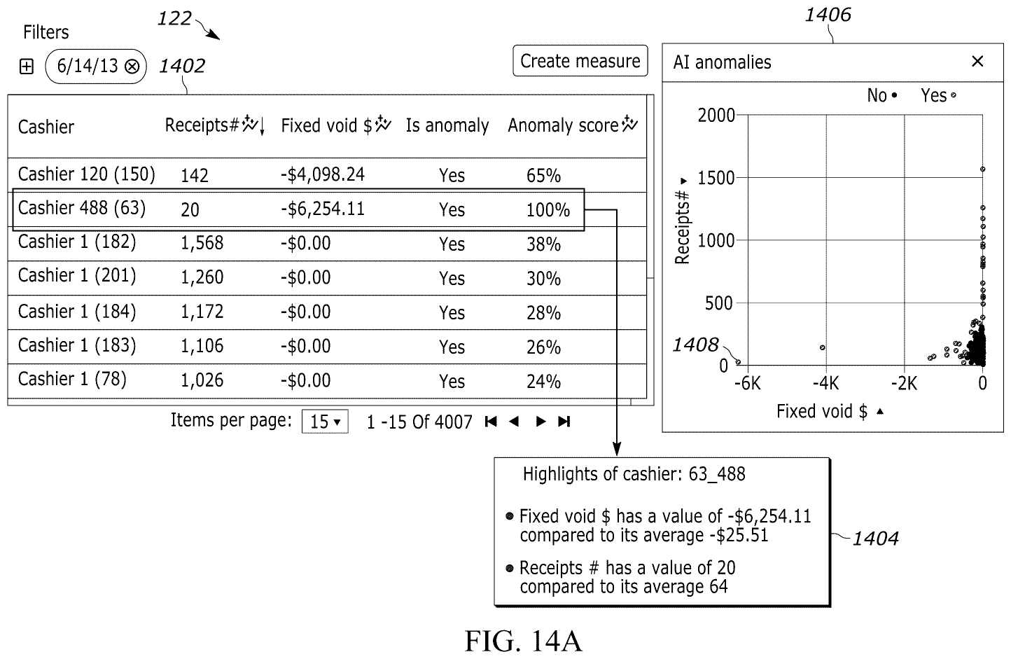

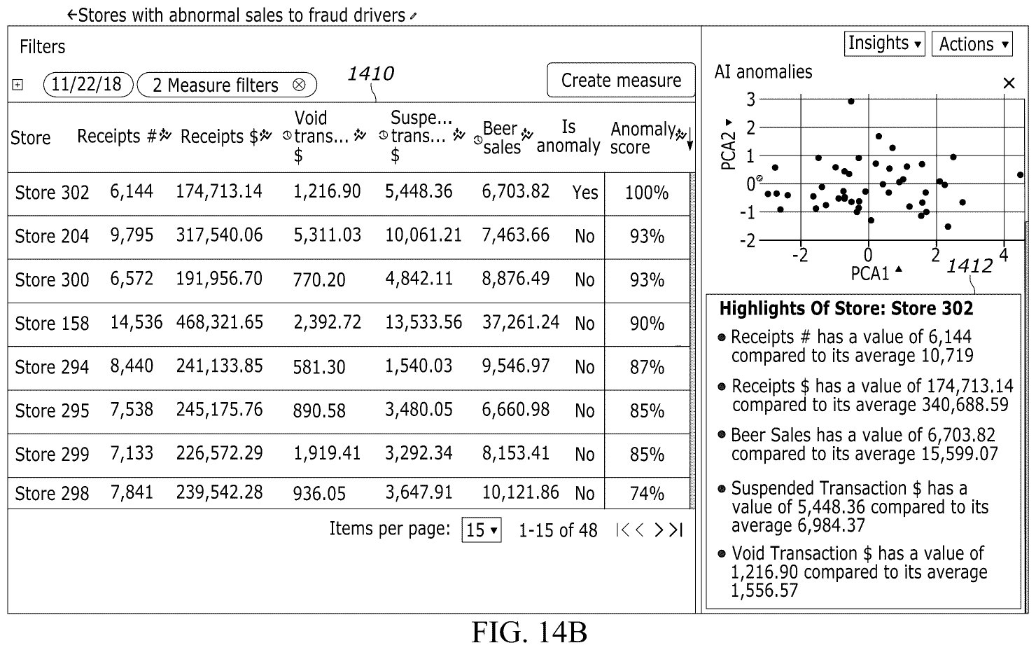

At block 112, the second dataset may be input to a machine learning model to detect one or more anomalies in the second dataset. The machine learning model may be an unsupervised neural network, such as an autoencoder neural network, and may be trained in real-time on data. The machine learning model may receive data and analyze the data to determine a rule for the second dataset, then reconstruct the second dataset based on the rule. A machine learning model may determine whether there is an anomalous item, (e.g., a caught item) present for a given dimension. For example, in FIG. 14A, Cashier 488 (63) is noted as having an anomaly in the “Is Anomaly” column (“Yes”). The machine learning model may also determine a percent score for how similar a datapoint within the original dataset provided to the machine learning model is to the corresponding datapoint in the reconstructed dataset returned by the machine learning model, e.g. an anomaly score. For example, in FIG. 14A, the anomaly score for Cashier 488 (63) is 100%.

At block 114, a user may be provided with the reasons behind an anomaly. The user may determine how to apply additional anomaly or non-anomaly filters.

At block 116, the user may select a set of anomaly parameters for filtering the output of the machine learning model, such that only data of interest is displayed and/or saved and/or used for further analysis. The anomaly parameters may include an indication of an anomaly (“anomaly yes/no”), an anomaly score (“anomaly score 0-100%”), and a first and second principal component of a principal component analysis (“PCA1 and PCA2”).

At block 118, the user may filter the dataset output by the machine learning model according to one or more anomaly parameters to narrow the dataset output by the machine learning model.

At block 120, a set of instructions (e.g., a pattern) for identifying anomalous items may be generated. The set of instructions is a continuous and autonomous pattern for scanning a dataset for anomalies responsive to updates to the dataset. The set of instructions may be based on the set of data parameters, the predefined filter, the second set of data parameters, the second set of anomaly parameters, and the set of detection pattern parameters. The set of data parameters define the dataset that the machine learning model is to analyze for anomalies. The anomaly parameters are used to filter the dataset output by the machine learning model such that the pattern scans a dataset for members fitting the anomaly detection criteria.

The user may select a set of detection pattern parameters to further define the set of instructions for anomaly detection. The set of detection pattern parameters may include a time frame indicating which values to include in a second dataset, a schedule for further anomaly detection, one or more prescriptive actions associated with the one or more anomalous items, a security level associated with the one or more anomalous items, and/or a responsibility level associated with the one or more anomalous items. The time frame indicates which values to include in the dataset to be analyzed, e.g., the past 7 days, the past 30 days, etc. The schedule for anomaly detection includes the frequency of executing anomaly detection, e.g., daily, monthly, after a set number of occurrences etc., and may include a start date and an end date for executing anomaly detection. The schedule may also include the type of calendar on which the anomaly detection is run, and whether anomaly detection is run automatically or at a specific time. The prescriptive actions include information about the anomaly, why a value is anomalous, and what actions to take in response to detecting an anomaly to correct the anomaly. The security level may indicate which users are allowed to access information about and/or take action in response to the anomaly. The responsibility level may indicate which users are responsible for taking action in response to the anomaly.

At block 122, the set of instructions may be executed to detect anomalous items within the system (e.g., caught items).

At block 124, the user responsible for handling the caught item may be provided with information about the one or more anomalous items. Such information may include an opportunity or task for the item that provides an explanation of the anomaly and/or reason for the pattern for anomaly detection, a reason for why the item has been flagged, and/or a prescriptive action (i.e., corrective action) to take in response to the anomalous item. Analytical views and other data visualizations may be displayed to provide more information about the anomaly. In some embodiments, the prescriptive actions may be communicated to an external task management system. In some embodiments, the prescriptive actions communicated to the external task management system may not include any data identifying the anomalous items, such that a user of the external task management system may not be able to view details such as a reason an item is anomalous.

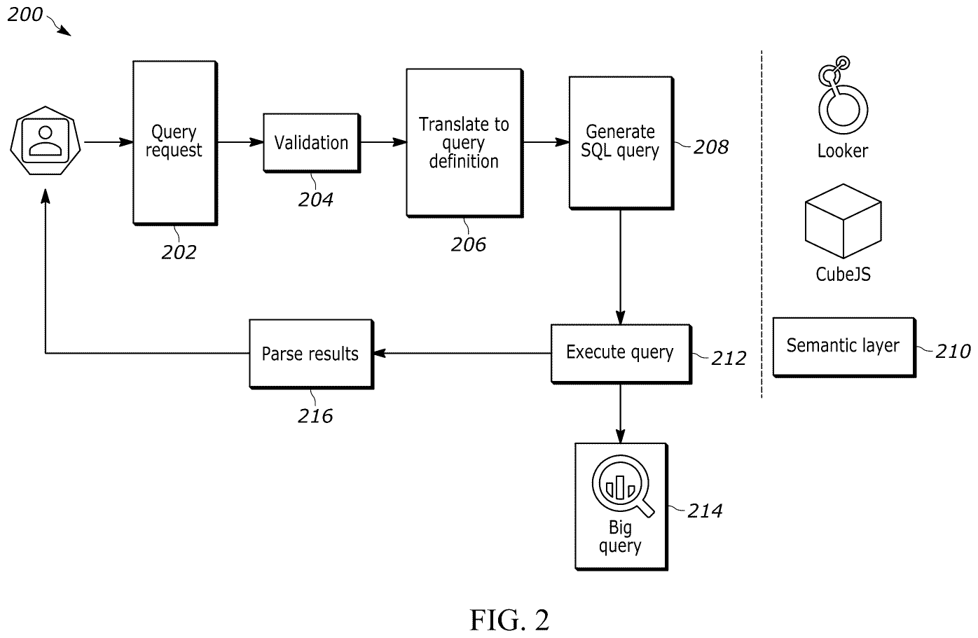

FIG. 2 depicts an example process of selecting a set of data parameters and retrieving data from a database according to the selected set of data parameters, according to some aspects and FIG. 3 is a diagram illustrating the selection of a set of data parameters and the retrieval of data from a database according to the selected set of data parameters, according to some aspects.

FIG. 2 depicts a combined block and flow diagram of an example of retrieving a dataset from a database. A set of data parameters may be used to create a query request 202, which then undergoes validation at block 204. The set of data parameters may then be translated to a query definition at block 206 which may used to generate a query in a programming language for storing and processing information in a relational database at block 208. For example, in FIG. 2A, the programming language is SQL, though other database languages may be used. A semantic layer 210 may map different terms used by different parts of a company that refer to the same thing to one data entity for a single view of the data, and other applications may be used to allow for analysis and viewing of data for users who are less familiar with database programming languages. At block 212, the query may be executed to retrieve data from a database 214, such as Google Big Query. The results (i.e., a dataset) may be parsed at block 216 and returned to the user.

FIG. 3 depicts an example of a dataset retrieved from a database. A dataset is retrieved according to the parameters. Data parameters may include a dimension 220 (i.e., an entity to observe) and measures 222 that are associated with a dimension 220 and may include metrics for the dimension 220. For example in FIG. 3, a dataset containing data about cashiers 224 (a dimension), and measures including a number of receipts generated by each cashier (receipts #) 226, a dollar amount of voided transactions processed by a particular cashier (fixed void $) 228, a dollar amount of discounts processed by a particular cashier (discount $) 230, and a number of discounted items processed by a particular cashier (discount #) 232 are retrieved from the database in accordance with the selected set of data parameters.

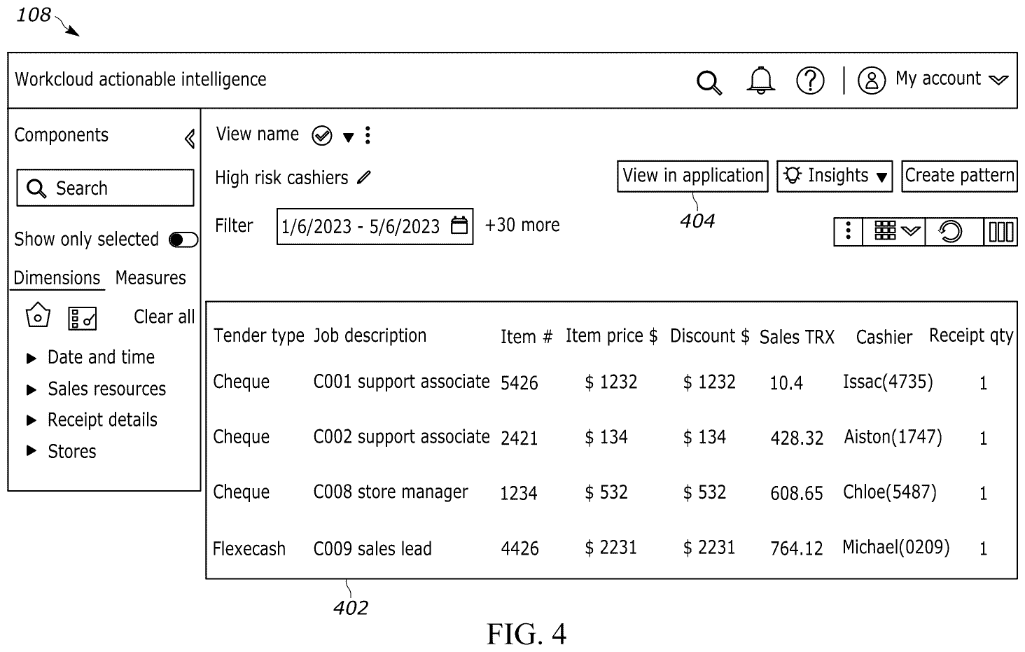

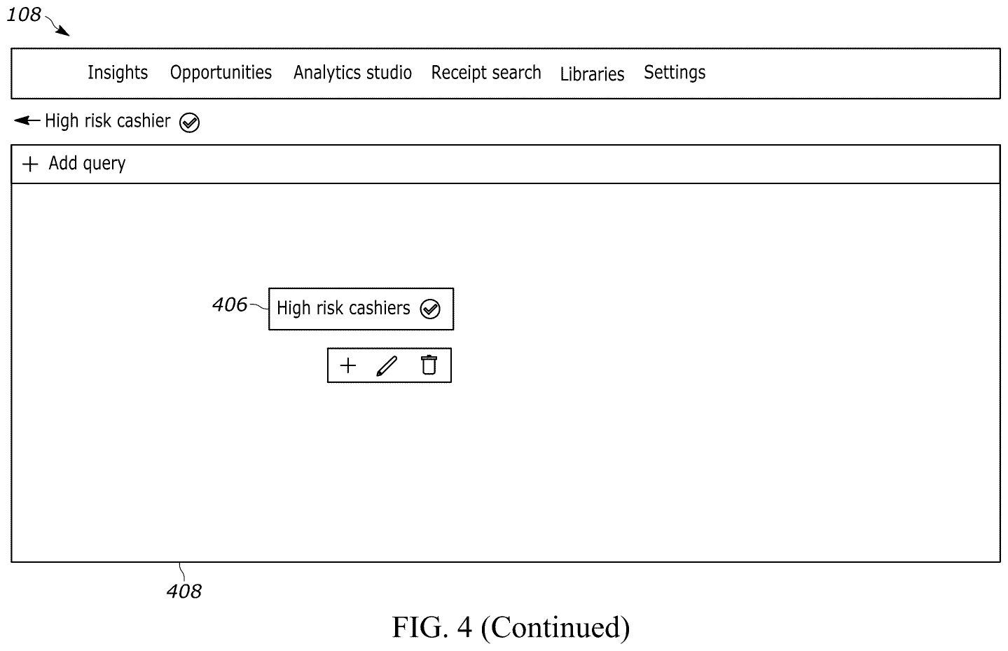

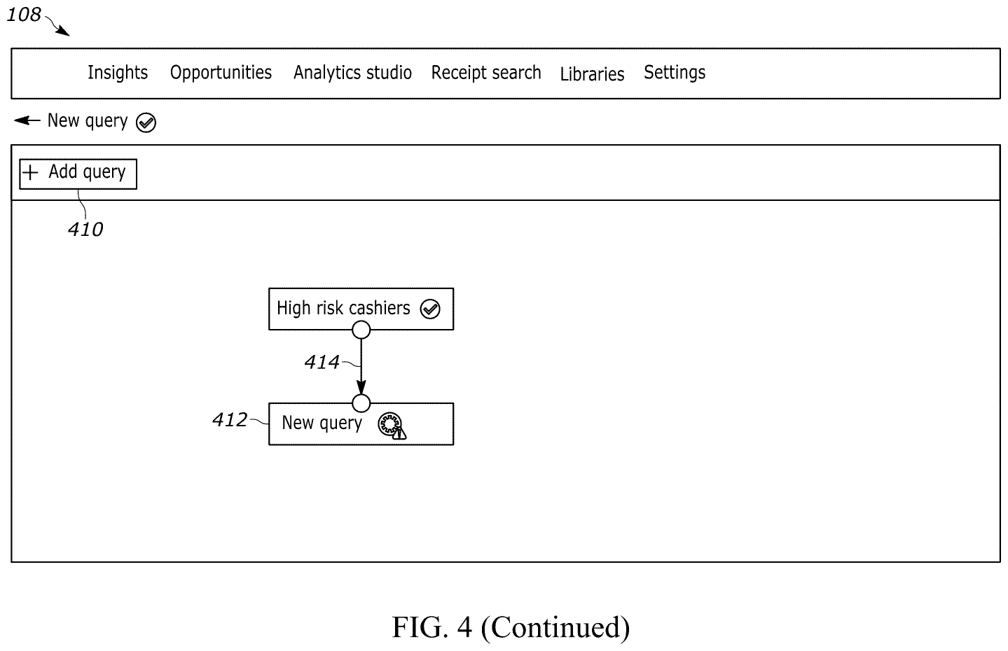

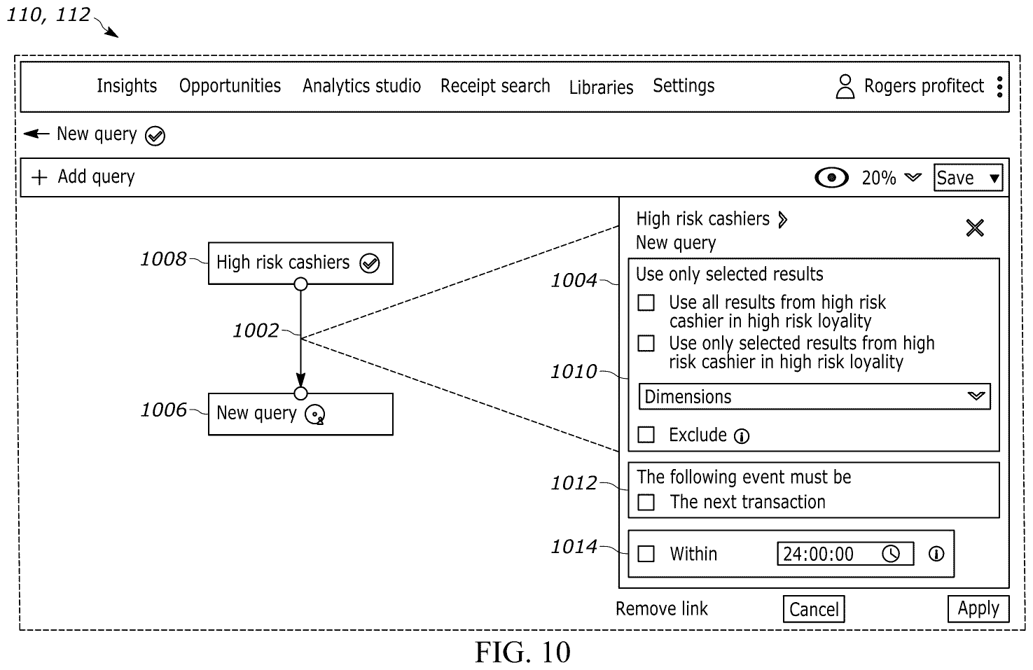

FIG. 4 depicts an example of creating and linking queries in a user interface (UI), according to some aspects. Table 402 shows data associated with a query about high risk cashiers. A user may select a “View In Application” icon 404 to view the query 406 in the user interface 408. The user interface 408, which is viewed in an application page, is used to facilitate user interaction with a computing device (e.g., device 1908 of FIG. 19) to create and link queries. A user may select an “Add Query” icon 410 to add a new query 412. The user can connect the new query 412 to the query 406 with a link 414. Connecting the new query 412 with the query 406 with the link 414 may cause one or more predetermined filters to be displayed in the user interface 408, as described in more detail in FIG. 10.

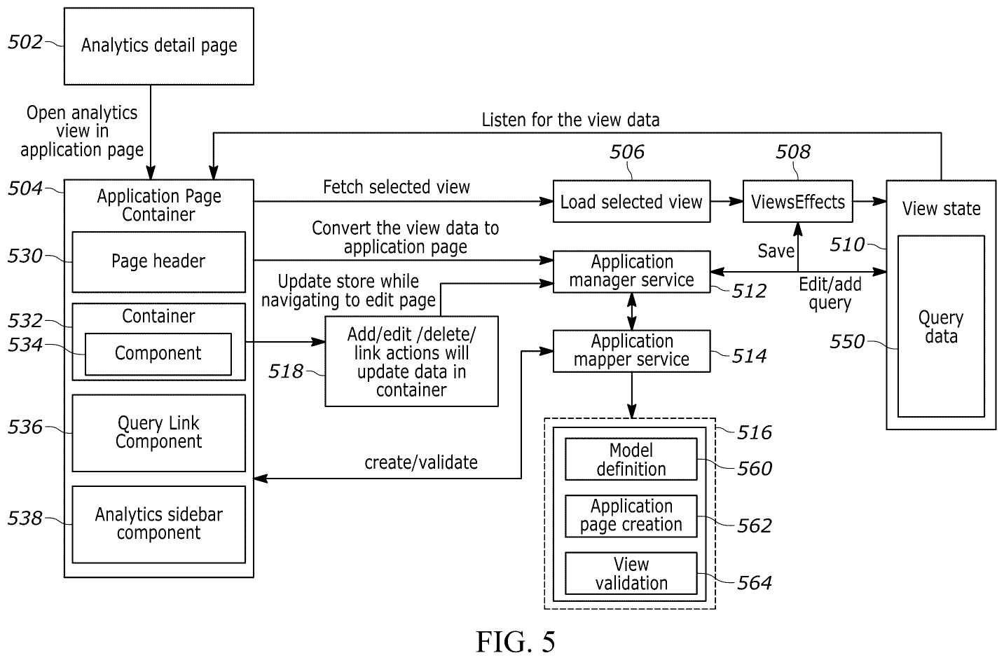

FIG. 5 depicts an example block and flow diagram of creating and linking queries in a UI, according to some aspects. A user interface generation module, such as the user interface module 1934 of FIG. 19, may be used to generate and link queries in a user interface, and may include an application page container 504, a ViewsEffects module 508, a View State module 510, an application manager service module 512, and an application mapper service 514.

An application page container 504 may receive a request to open an analytics view in a user interface for creating and linking queries from an analytics detail page 502. The application page container 504 describes objects that appear in the user interface. The application page container 504 may include a page header 530, a container 532, a query link component 536, and an analytics sidebar component 538. The page header 530 may define an area at the top of the user interface and may hold text and/or image content. The container 532 may be used to define an area of the user interface used to place and depict queries and links, and may hold text and/or image content. A user may interact with the area defined by the container 532 to place graphical depictions of queries and links, for example. At block 518, the container 534 may interact with the application manager service 512 to perform add, edit, delete, and/or link actions to queries depicted in the area defined by the container 532. Such actions will update data in the container 532. The container 532 may include a component 534, which may hold text and/or image content placed into the container 532. For example, the component 534 may be a depiction of a query. The query link component 536 defines a graphical depiction of a link. For example, the graphical depiction of the link may appear as the link 414 of FIG. 4. The analytics sidebar component 538 defines a graphical depiction of a set of predetermined filters. For example, an analytics sidebar component may appear as the predetermined filters 1004 of FIG. 10. The analytics sidebar component 538 may be interactable. For example, a user may interact with an analytics sidebar to select a parameter that describes a behavior between queries, such as a parameter indicating that all results of a first query must be used in a second linked query.

At block 506, the application page container 504 may attempt to load a selected view. The request of the selected view may be passed to a ViewsEffects module 508. The ViewsEffects module 508 may communicate with a View State module 510. The View State module 510 may also listen for view data from the application page container 504. The View State module 510 may store query data 550 (e.g., data about the queries depicted in the user interface). The ViewsEffects module 508 may also interact with the View State module 510 to edit and/or add queries in the user interface and save a view (e.g., what is visually shown on the user interface, including what objects are shown in the UI, the position of objects, etc.). The ViewsEffects module 508 and View State module 510 may also interact with an application manager service module 512 to communicate data such as query data 550.

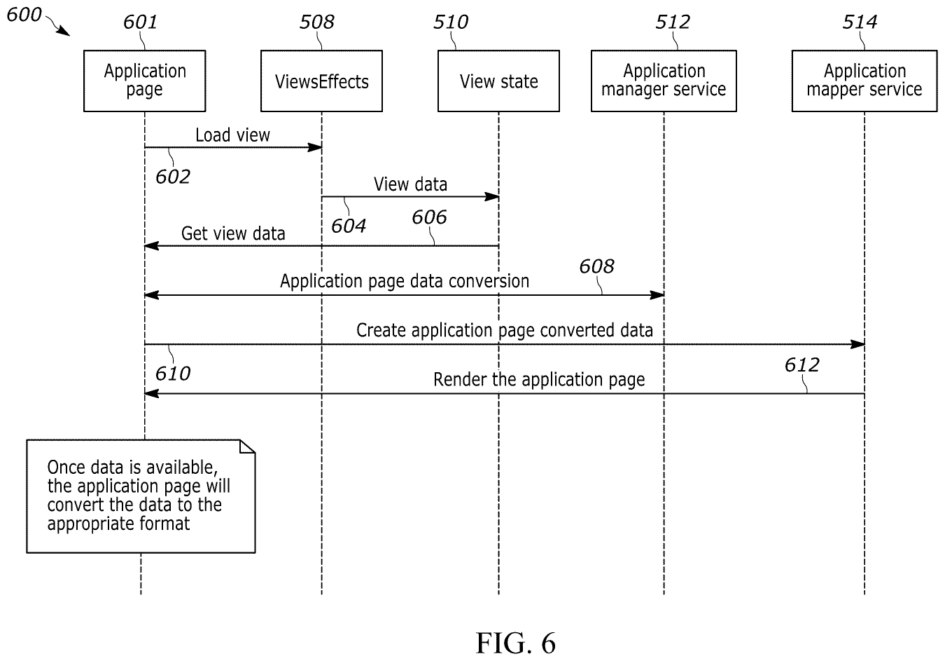

The application manager service module 512 may receive a request from the application page container 504 to convert view data to application page data, as described in FIG. 6. The application manager service 512 may also communicate with an application mapper service 514, as described in FIG. 6.

The application mapper service 514 may include information 516 such as a model definition 560, instructions for application page creation 562, and instructions for view validation 564. The application mapper service 514 creates and renders the data to be displayed in the area defined by the application page container 504 (e.g., user interface).

FIG. 6 depicts an example sequence diagram of a sequence 600 for rendering the UI in the application page according to some aspects. The sequence 600 includes a timeline of events affecting an application page 601 and different modules of FIG. 5, including ViewsEffects module 508, View State module 510, Application manager service 512, and application mapper service 514.

Sequence 600 may begin at a step 602, where an application page 601 transmits a request to the ViewsEffects module 508 to load a view of queries displayed in the application page 601.

At step 604, the ViewsEffects module 508 may transmit a request for view data, which includes data describing what query data and other objects are displayed on the application page 601, from the View State module 510.

At step 606, the View State module 510 may transmit the view data to the application page 601. At a step 608, the application page 601 may communicate with the application manager service 512 to convert the view data to application data. The application page 601 may transmit the data to the application manager service 512 and receive the converted data.

At step 610, the application page 601 may transmit a request to the application mapper service 514 to create an application page 601 with the converted data. The application mapper service 514 may render application page 601 at step 612.

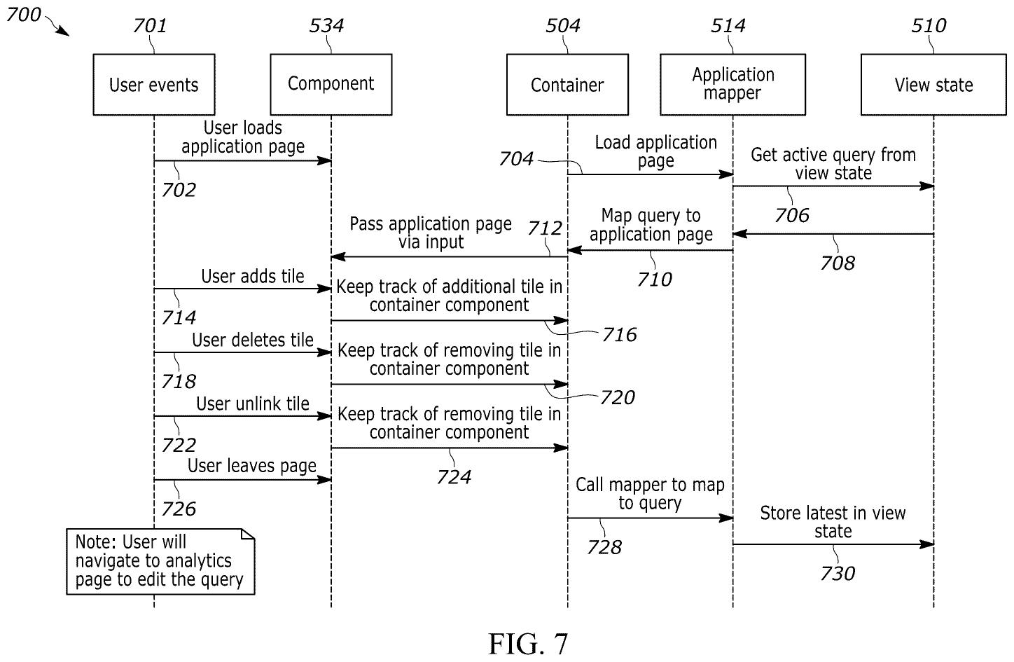

FIG. 7 depicts an example sequence diagram for a sequence 700 for creating and linking queries in the UI, according to some aspects. The sequence 700 may include a timeline of events including user events 701 and affecting a component 534, a container 504, an application mapper 514, and a view state module 510.

At step 702, a user may load an application page. A request is transmitted to the component 534 to load a component. At step 704, the container 504 may load an application page by transmitting a request to the application mapper 514. At a step 706, the application mapper 514 may transmit a request to get an active query from the view state module 510. At a step 708, the view state module 510 transmits the active query (e.g., application page data) to the application mapper 514. At step 710, the application mapper 514 maps the query to the application page and transmits the mapped query to the container 504. At step 712, the container 504 transmits the application page via input to the component 534.

A user event 701 may include edits to the application page and/or query, such as adding, deleting, and/or unlinking queries. A user may also interact with an analytics page 502 as shown in FIG. 5 to edit a query. At a step 714, a user may add a tile (e.g., a visual depiction of a query) by transmitting a request to the component 534. At step 716, the component 534 may communicate with the container 504 to keep track of the additional tile in the container 504. At a step 718, a user may delete a tile by transmitting a request to the component 534. At step 720, the component 534 may communicate with the container 504 to keep track of removing the tile in the container 504. At a step 722, a user may unlink a tile from another tile by transmitting a request to the component 534. At step 724, the component 534 may communicate with the container 504 to keep track of removing the link in the container 504.

At step 726, the user may leave the page. At step 728, the container 504 may call the application mapper 514 to map any changes (e.g., adding a tile, deleting a tile, unlinking a tile) to a query. Such changes to the components displayed in the user interface correspond to changes in the queries. For example, adding an additional query tile and linking it to the first query tile in the user interface will logically link the additional query and first query together such that results from the additional query will be based at least in part on the first query. The application mapper 514 may map the changes and transmit the query to the view state module 510 to store the latest view of the application page at step 730.

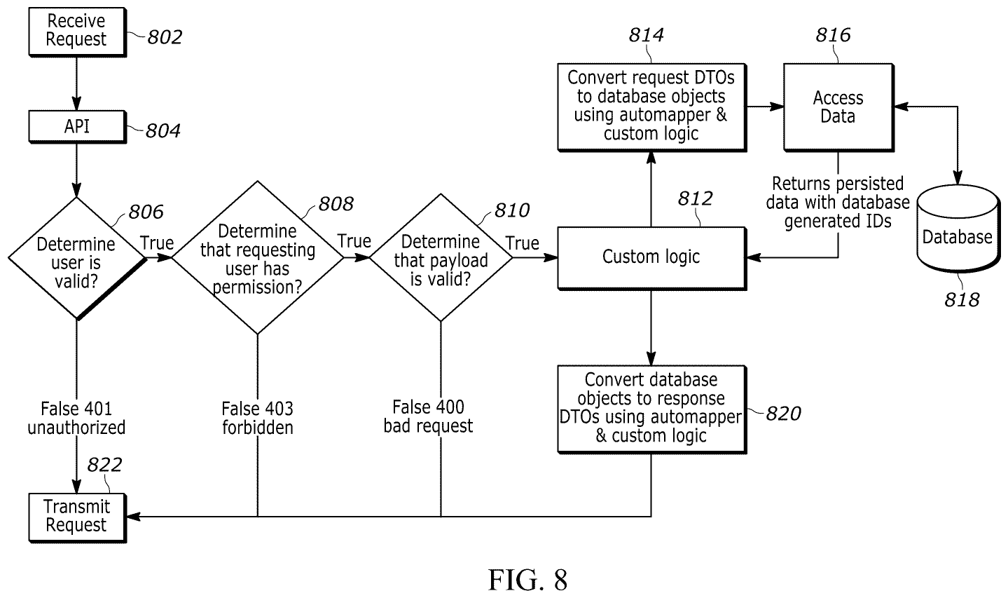

FIG. 8 depicts an example flow diagram for linking queries and retrieving data to link the queries in a user interface (i.e., an application page). The method depicted in FIG. 8 may be performed by the system of FIG. 19.

At block 802, a user device may submit a request for creating and/or linking a query. A user may interact with a user interface to link the queries by placing a connecting line between images of boxes representing the queries, for example. The request may be handled by one or more APIs 804 (which may be the cloud APIs 1914 depicted in FIG. 19).

At block 806, the APIs 804 may determine whether a user submitting the request is a valid user. If the user is not a valid user, at block 822, a response is returned indicating the user is unauthorized. If the user is a valid user, the method proceeds to block 808.

At block 808, APIs 804 may determine whether the user submitting the request has permission access the requested data. If the user submitting the request does not have permission, a response indicating the user is forbidden from accessing the data is returned at a block 822. If the user has permission, the method proceeds to block 810.

At block 810, APIs may determine if the payload (e.g., of the request). If the payload is not valid, a response indicating a bad request is returned at block 822. If the payload is valid, the payload is transmitted to a custom logic module 812.

Custom logic 812 may be defined and/or customized depending on a particular application of the anomaly detection system. For example, custom logic 812 may include defining dimensions such as cashiers, transactions, etc.

At block 814, a request database transfer object (DTO) may be converted to a database object using an automapper and custom logic. The DTO is an object used to encapsulate data and send the data between processes.

At block 816, data is accessed from a database 818, and persisted data with database generated IDs is returned to the custom logic module 812. The data may correspond to a query or a result of a query. At block 820, the database objects are converted to response DTOs using the automapper and custom logic. The response DTO is returned to the user at block 822.

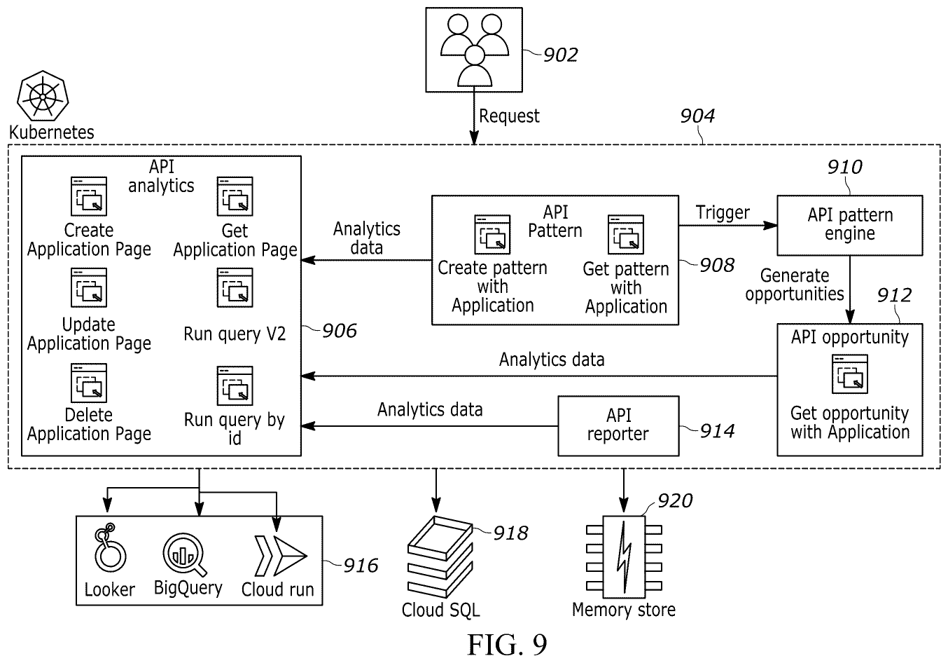

FIG. 9 depicts a diagram of anomaly detection for multiple linked queries, according to some aspects.

Users 902 may submit a request by interacting with a user interface (e.g., an application page) that calls one or more APIs 904, which may interact with each other. In some embodiments one or more of the APIs 904 may be cloud APIs 1914 as depicted in FIG. 19. The APIs 904 may include an analytics API 906, a pattern API 908, a pattern engine API 910, an opportunity API 912, and a reporter API 914. The APIs 904 may interact with a cloud SQL database service 918 and a memory store 920. The APIs may be implemented as endpoint accessible via a web service protocol, such as representational state transfer (REST), Simple Object Access Protocol (SOAP), JavaScript Object Notation (JSON), etc.

An API analytics module 906 may be used to perform operations in the user interface and to run queries. For example, the API analytics module 906 may be used to create an application page, get an application page, update an application page, delete an application page, run a query, and/or run a query by ID, according to a request submitted by the users 902. The API analytics module 906 may interact with external applications 916, which may be or use cloud APIs 1914. The external applications 916 may include cloud applications for data exploration, coding, and cloud databases.

A API pattern module 908 may be used to create and/or get a pattern using the application page (user interface), according to a request submitted by the users 902. The API pattern module 908 may trigger a pattern engine API 910. The API pattern module 908 may also communicate analytics data to the analytics API 906.

The API pattern engine module 910 may perform the backend logic to create and execute patterns for anomaly detection. The API pattern engine module 910 may also work with an API opportunity module 912 to generate opportunities.

The API opportunity module 912 may work with the pattern engine API 910 to generate opportunities and get opportunities using the application page. The API opportunity module 912 may transmit analytics data to the API analytics module 906.

The API reporter 914 may report data for storage and transmit analytics data to the API analytics module 906.

FIG. 10 depicts an example UI with example predefined filters for linking queries. A set of predefined filters 1004 corresponds to the link 1002 such that the data resulting from query 1006 is based on the filters 1004. In some embodiments, a user may use a UI to select predetermined filters 1004 by interacting with a depiction of a link 1002 in the UI. In some embodiments, the predefined filters 1004 may include a behavior between queries option 1010 of a first query 1008. For example, all results or only selected results of the first query 1008 may be passed to the new query 1006. In some embodiments, some results of the first query 1008 may be excluded. The predefined filters 1004 may additionally or alternatively include a next transaction option 1012 of whether a result of the new query 1006 must be a next transaction. For example, if a first query is directed to cashiers performing a no-sale transaction, and the new query is directed to a cashier performing a void transaction, the next transaction option 1012 may be selected to indicate the void transaction must be the next transaction after a no-sale transaction. In some embodiments, predefined filters 1004 may additionally or alternatively include a window functionality option 1014 to indicate that a result of the new query 1006 must have occurred within some amount of time after a datapoint indicating an event resulting from the first query 1008. For example, if a first query 1008 is directed to cashiers performing a no-sale transaction, and the new query 1006 is directed to a cashier performing a void transaction, the window functionality option 1014 may be selected to indicate the void transaction must occur within 5 minutes of a no-sale transaction.

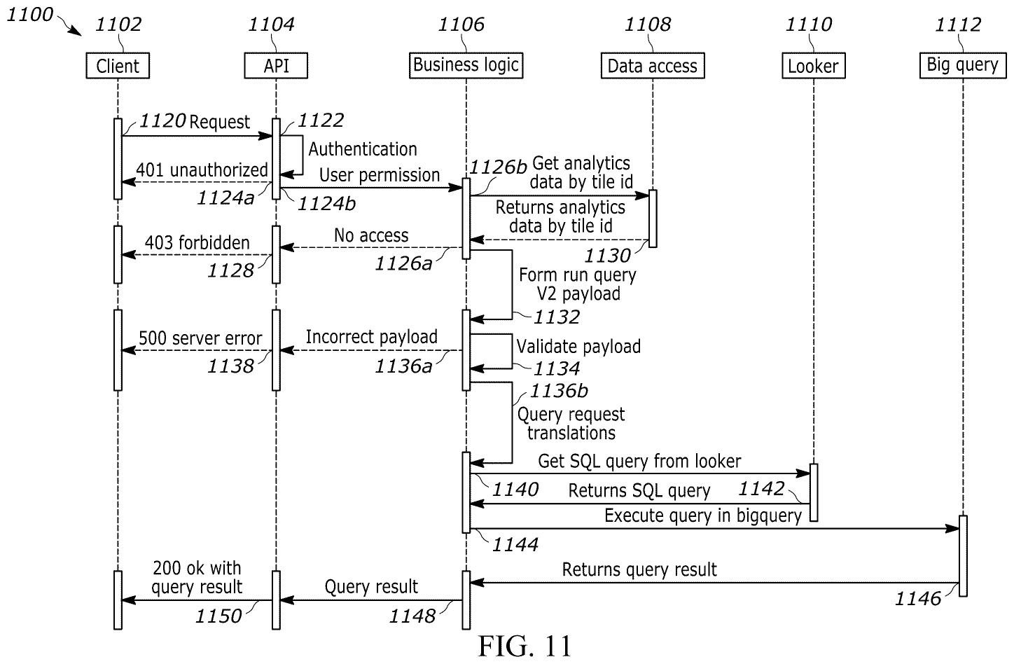

FIG. 11 depicts an example sequence diagram for a sequence 1100 for retrieving data. The sequence 1100 may include a timeline of events affecting a client 1102, an API 1104, a business logic module 1106, a data access module 1108, a data exploration service 1110, and a cloud database 1112.

At step 1120, a client 1102 may submit a request to retrieve data from an API 1104.

At step 1122, the API 1104 may perform authentication. If authentication of the request fails, at step 1124a, a response indicating the client is unauthorized is transmitted to the client 1102. If the request is authenticated, the API 1104 passes the request to the business logic module 1106 and asks if the user has permission to access the requested data.

At step 1126a, if the client 1102 does not have permission, the business logic module 1106 may transmit a response that the client 1102 has no access to the API 1104. The API 1104 may transmit a message 1128 that the client 1102 is forbidden from accessing the data. If the client 1102 has permission, at step 1126b the business logic module 1106 transmits a request to get analytics data by tile ID to the data access module 1108. At step 1130, the data access module 1108 returns analytics data by tile ID.

At step 1132, the business logic module 1106 forms a run query v2 payload. At step 1134, the business logic module 1106 validates the payload. At step 1136a, if the payload is not validated, the business logic module 1106 may transmit an indication that the payload was incorrect to the API 1104. At step 1138, the API 1104 may transmit a response to the client 1102 indicating a server error. If the payload is validated, at step 1136b the business logic module 1106 translates the query request.

At step 1140, the business logic module 1106 transmits the translated query with a request to retrieve the translated query in SQL (i.e., a SQL query) from a data exploration service 1110 (e.g., Looker). At step 1142, the data exploration service 1110 returns the SQL query to the business logic module 1106.

At step 1144, the business logic module 1106 executes the query in a cloud database 1112 (e.g., Big Query) to retrieve data corresponding to the query (e.g., a query result). At step 1146, the cloud database 1112 returns the query result to the business logic module 1106.

At step 1148, the business logic module 1106 transmits the query result to the API 1104. At step 1150, the API 1104 transmits an indication that the query was accepted with the query result.

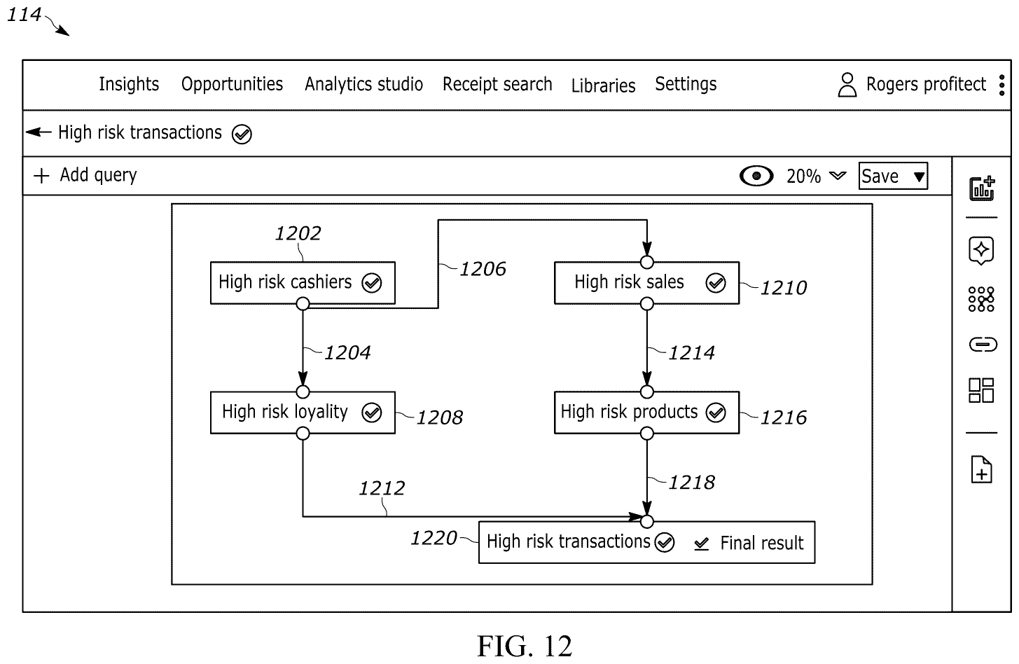

FIG. 12 depicts an example of multiple linked queries. In some aspects, one query of a plurality of queries may be linked to the first query. For example, a query 1208 (“High Risk Loyalty”) may be connected with a link 1204 to a first query 1202 (“High Risk Cashiers”). In some aspects, more than one query of a plurality of queries may be linked to the first query. For example, in addition to the query 1208, a query 1210 (“High Risk Sales”) may also be connected through a link 1206 to the query 1202. In some aspects, one query of a plurality of queries may be linked to another query that is linked to the first query (e.g., indirectly link to the first query). For example, a query 1216 (“High Risk Products”) may be connected with a link 1214 to the query 1210, and a query 1220 (“High Risk Transactions”) may be connected to the queries 1208 and 1216 through the links 1212 and 1218, respectively. In some aspects, real-time updates to a first query will propagate in real-time through linked queries that are dependent on the first query. For example, a real-time update to the query 1202 will cause the queries 1208, 1210, 1216, and 1220 to also update in real-time based on the updates to the query 1202.

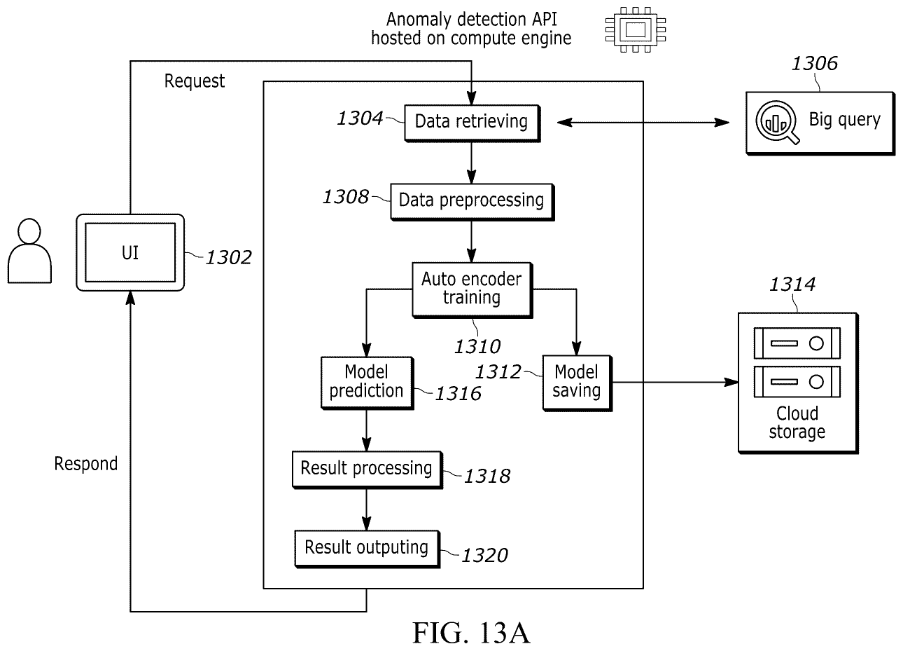

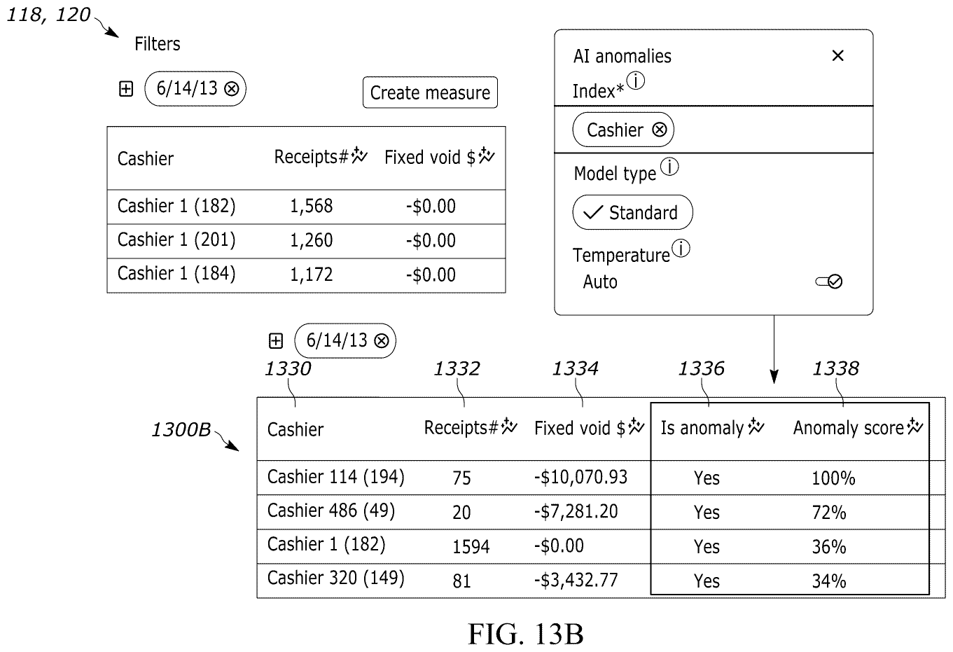

FIGS. 13A-13B depict the process of anomaly detection.

As shown in FIG. 13A, a request may be submitted by a user via a user interface such as user interface 1302. The request may call an anomaly detection application programming interface (API), for example, stored at the memory of a server providing anomaly detection services such as the memory 1926 of the server 1904 in FIG. 19. The API may be implemented as an endpoint accessible via a web service protocol, such as representational state transfer (REST), Simple Object Access Protocol (SOAP), JavaScript Object Notation (JSON), etc. After a request has been submitted, data is retrieved from a database 1306 at block 1304 according to a set of data parameters, as described in FIGS. 2 and 3. The data may be preprocessed at block 1308 to transform the data for analysis and input to the machine learning model. For example, the data may be cleaned, normalized, filtered, undergo feature extraction, undergo feature selection, or may be otherwise transformed in preparation for analysis. The preprocessed data may then be input to a machine learning model for training and predictions.

The machine learning model may be trained at block 1310. In some embodiments, the machine learning model may be an autoencoder neural network as shown in FIG. 13A. The autoencoder has an encoding function and a decoding function. The encoding function translates the input data into a latent space, thus deriving rules from the dataset. The decoding function reconstructs input data from the latent space based on the rules derived from the encoding step. In some implementations, the autoencoder may be trained in real-time on newly collected and/or updated data. The trained model may be saved in cloud storage at block 1314. At block 1316, the model may predict anomalous datapoints in the dataset by comparing reconstructed data to the input data to generate an anomaly score. Datapoints from the reconstructed dataset that deviate from the corresponding input datapoint (i.e., have a high anomaly score) are considered anomalous. The results of the prediction are processed at block 1318 and the output is transmitted to the user interface 1302 at block 1320.

The use of an autoencoder offers advantages, such as real-time training on newly updated data. However, other machine learning techniques may be used. For example, the machine learning model may employ various machine learning methods and algorithms such as linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines, which may be directed toward one or more categorizations of machine learning, including supervised learning, unsupervised learning, and reinforcement learning.

FIG. 13B depicts an example dataset which is processed to detect anomalies, the results of the anomaly detection, and filtering of such results. For example, as shown in FIG. 13B, a dataset 1300B may include a cashier 1330, a receipts #1332 indicating a number of transaction receipts generated by the corresponding cashier, and a fixed void $ 1334 indicating an amount of voided transactions in dollar amounts for the corresponding cashier. The results of anomaly detection output from the machine learning model may include whether there is an anomaly associated with a particular cashier (“Is Anomaly” column 1336) and an anomaly score 1338 indicating, in the illustrated example, an anomaly assurance percentage. Other example anomaly detection output data from the machine learning model include averages and other statistical values for a measure, and a percent difference between a value for a measure and the average value for a measure. In some implementations, the anomaly detection output data may be graphically displayed. These results (i.e., the anomaly detection output alone or in combination with the input data fed to the anomaly detection system) may also be filtered according to a set of anomaly parameters to narrow the dataset that is shown. Such filtering may occur, for example, after the results of the machine learning model output to filter on the generated output. For example, in FIG. 13B, the results of the machine learning model output have been filtered to only show cashiers that have been flagged as anomalous (“Yes” in the “Is Anomaly” column 1336) and an anomaly score indicating how anomalous an item is (“Anomaly Score” column 1338).

FIGS. 14A and 14B depict filtering of the results of the anomaly detection process and the reasons for the anomaly. FIG. 14A depicts an example of detecting and filtering cashier anomalies. For example, table 1402 shows Cashier 488(63) as having an anomaly detected that is associated with that cashier. Block 1404 depicts the reasons why Cashier 488(63) was flagged as anomalous. For example, Cashier 488(63) had a fixed void $ value (−$6,254.11) that was much higher than the average ($−25.51), and a receipts # value (20) that was much lower than the average (64). While FIG. 14A depicts only one entity that has been flagged as anomalous (i.e., Cashier 488(63)), more than one entity may be anomalous. In some implementations, the reasons for the anomaly may be transmitted to a user computing device and/or task management service. Graph 1406 depicts a plot of datapoints in the dataset, with the points noted as either anomalous or not anomalous. Point 1408 refers to the fixed void $ value associated with the with the receipts # value of Cashier 488(63). The greater distance of point 1408 from the cluster of other datapoints indicate the point 1408 is anomalous.

FIG. 14B depicts an example of detecting and filtering store anomalies. For example, table 1410 shows “Store 302” as having an anomaly detected that is associated with that store. In some implementations, a measure associated with a particular entity may be flagged based on comparison with all other entities in a pool of entities. For example, as shown in block 1412, the receipt # value and receipt $ are significantly lower than an average receipts # and receipts $ of the pool of stores. However, the void transaction $ and suspended transaction $ are only marginally below the pool, leading to a 24% difference of void transaction $ and suspended transaction $ when compared to the pool of stores. Beer sales has a largest % difference to the pool and is abnormally low in comparison to the pool. “Store 302's” receipts #, receipts $, void transaction $, suspended transaction $, and beer sales are thus anomalous when compared to the pool of stores and indicate someone at “store 302 may be giving beer away, or that beer is being stolen. In some implementations, an entity may be flagged as anomalous on real-time, dynamic shifts in data. For example, a pool of entities as a whole may experience real-time, dynamic shifts affecting the measures, such that an entity may be flagged only if measures for that entity, when compared to the pool of entities, are outside the range of the real-time shifts experienced by the pool of entities.

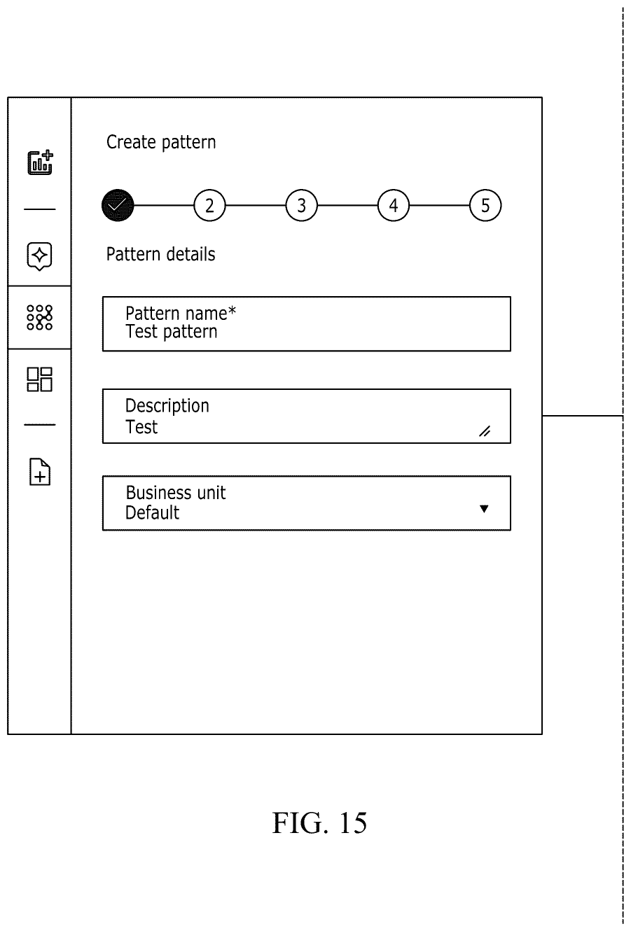

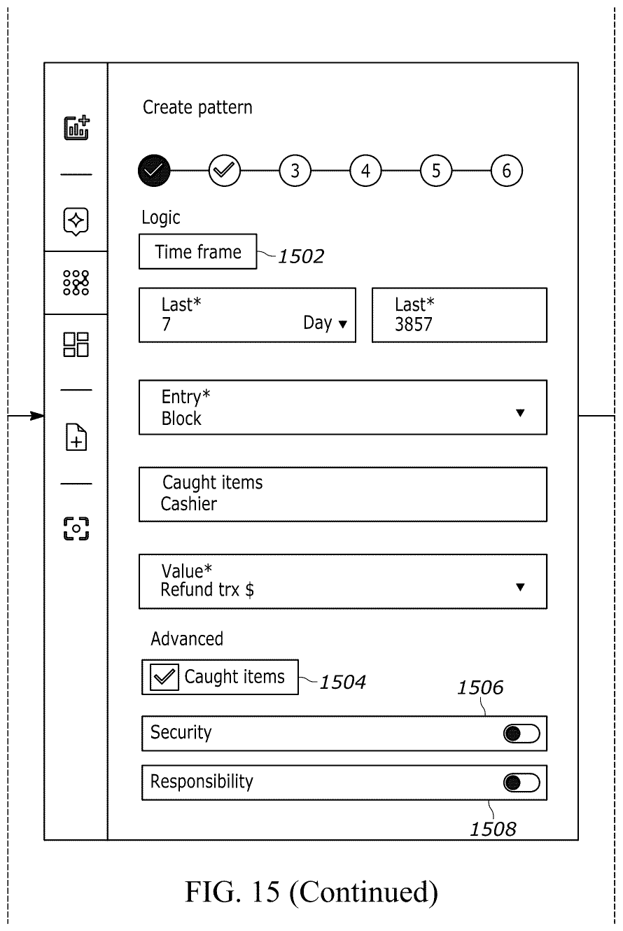

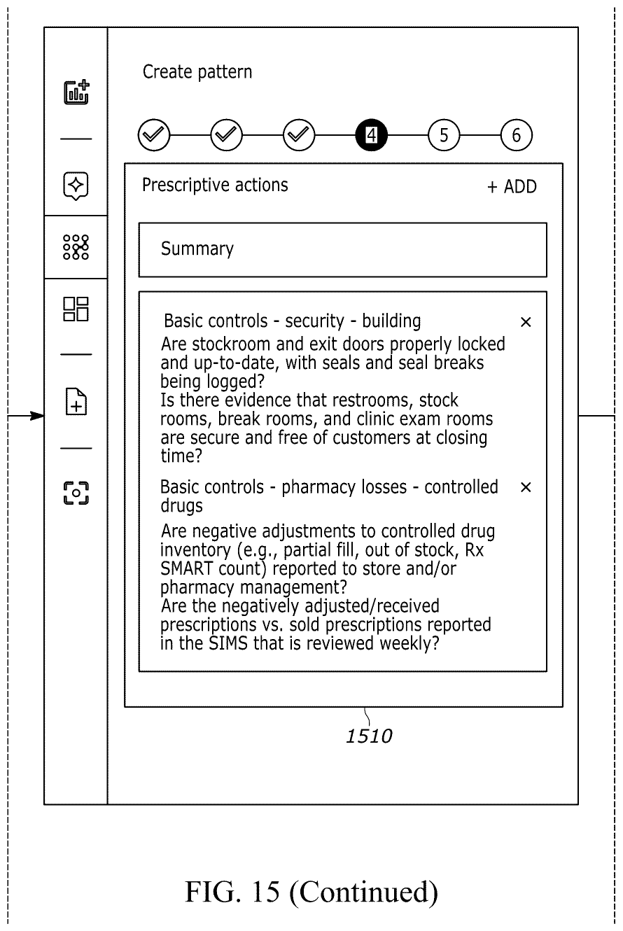

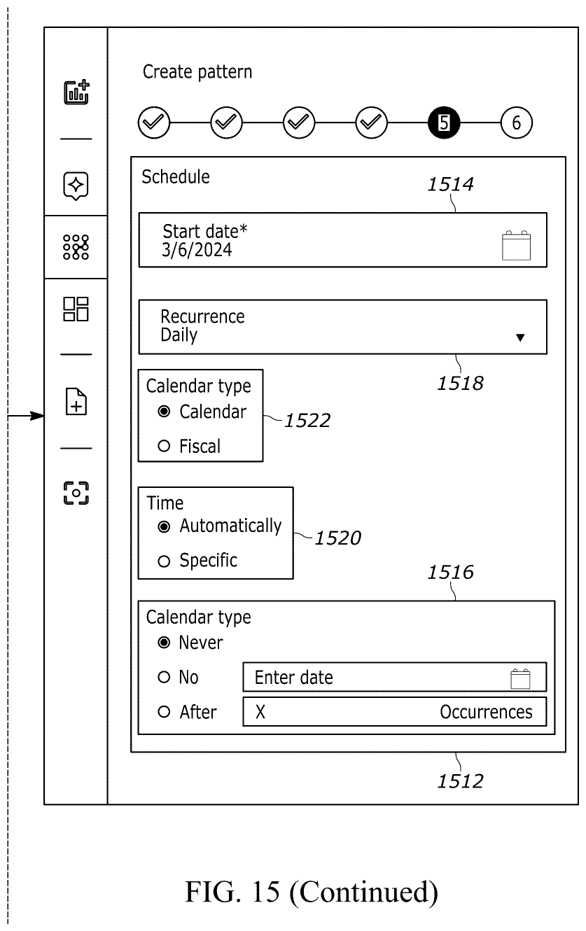

FIG. 15 depicts an example user interface for generating a set of instructions for identifying anomalous items responsive to updates to the dataset. Detection pattern parameters that are used to generate the set of instructions for identifying anomalous items include a time frame 1502, whether the item is a caught item 1504, whether the caught item should be assigned by security 1506 and/or whether the caught item should be assigned by responsibility 1508, prescriptive actions 1510, and a schedule 1512 for executing the instructions for identifying anomalous items. In some embodiments, prescriptive actions may be predetermined and selected by users. In some embodiments, prescriptive actions may be manually entered by the user via the user interface when creating the set of instructions for anomaly detection. The schedule 1512 may include a start date 1514 and/or an end date 1516, a recurrence 1518 (e.g., frequency) of anomaly detection, whether the anomaly detection is executed automatically or at a specific time 1520, and/or a type of calendar 1522 on which the anomaly detection runs. A user may select pattern parameters via a user interface.

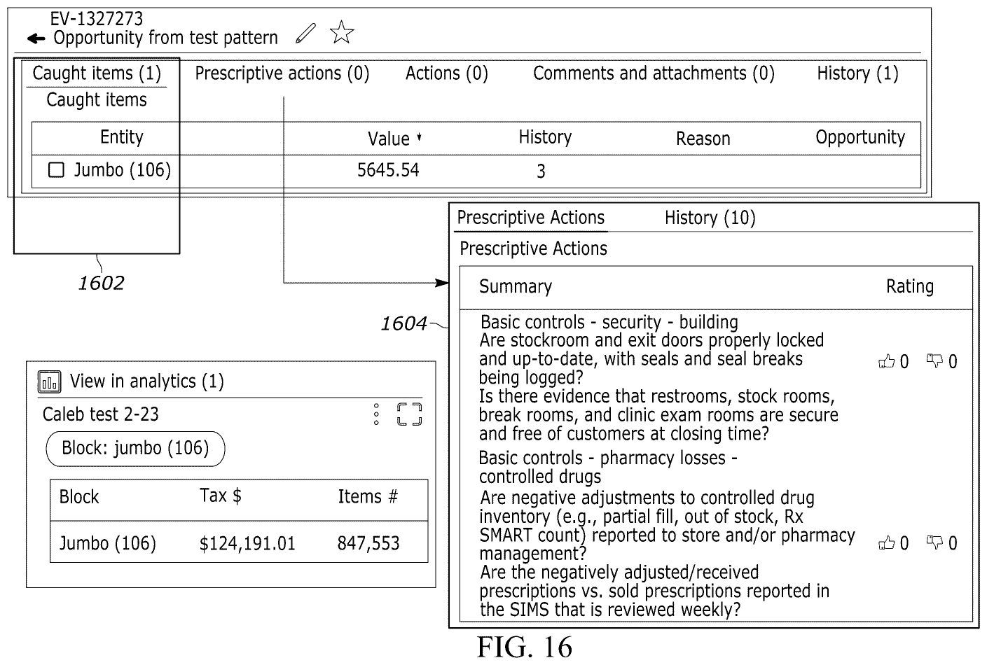

FIG. 16 depicts a user interface of a transmitted caught item 1602 and prescriptive actions 1604 to the appropriate user for handling the actions. The prescriptive action may be sent to a user based on responsibility and/or security. In some implementations, reasons for why the caught item is anomalous may be included.

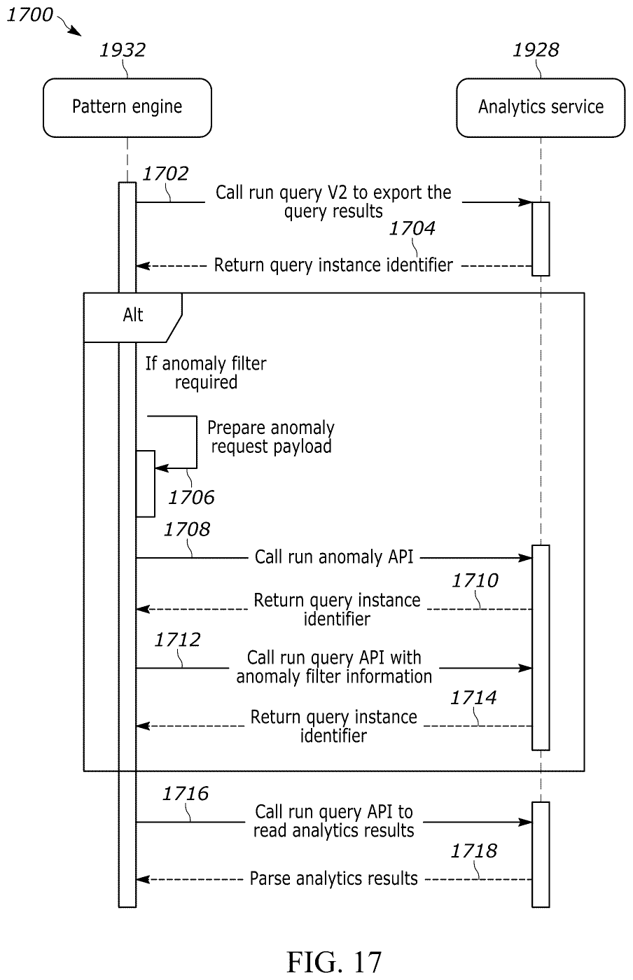

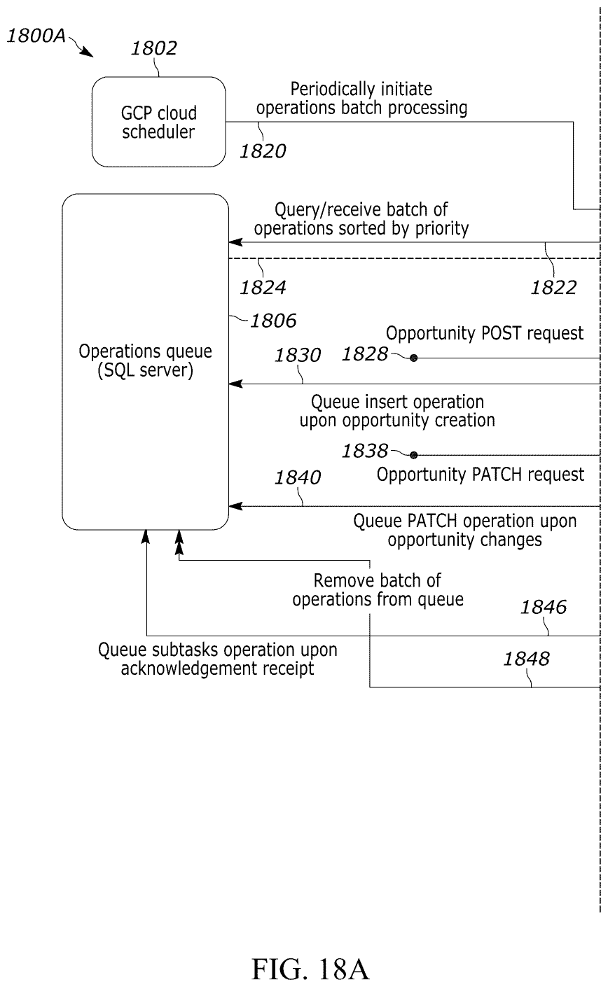

FIG. 17 depicts a sequence diagram for a sequence 1700 associated with executing a set of instructions for identifying anomalous items in real-time (i.e., pattern execution), as may be executed by a specific example implementation of the pattern engine and analytics service stored on the memory of a server such as the pattern engine 1932 and analytics service 1928 stored in the memory 1926 of server 1904 of FIG. 19. The sequence 1700 includes a timeline of events affecting a pattern engine 1932 and an analytics service 1928.

Sequence 1700 may begin at step 1702, when a pattern engine 1932 exports a data set to be analyzed to the analytics service 1928 (“Call RunQuery V2 to export the query results”). At step 1704, the analytics service returns a query instance identifier in response to the request from pattern engine 1932.

At step 1706, the pattern engine 1932 may prepare a payload for a request to filter the results of the anomaly detection with anomaly parameters if the pattern includes such filtering.

At step 1708, the pattern engine 1932 calls an API (“Run Anomaly API”) to run the set of instructions to identify anomalies. The API may be implemented as an endpoint accessible via a web service protocol, such as representational state transfer (REST), Simple Object Access Protocol (SOAP), JavaScript Object Notation (JSON), etc. The analytics service 1928 uses the machine learning model, as described above in FIG. 3A, to identify anomalous items and returns a query instance identifier at step 1710.

At step 1712, the pattern engine 1932 calls an API (“RunQuery API”) to transmit a request to the analytics service 1928 to filter the output of the machine learning model. The request may include a set of anomaly parameters to filter the data. At a step 1714, the analytics server 1928 returns a query instance identifier.

At step 1716, the pattern engine 1932 calls the RunQuery API to request the analytics service 1928 to read the analytics results. The analytics service 1928 may analyze the identified anomalous items to provide information about the anomalies. For example, the analytics service 1928 may determine a reason for why the item was flagged as anomalous and/or prescriptive actions for correcting the anomalous item based on the instructions in the pattern. At step 1718, the analytics service 1928 may transmit analytics about the anomaly to the pattern engine 1932.

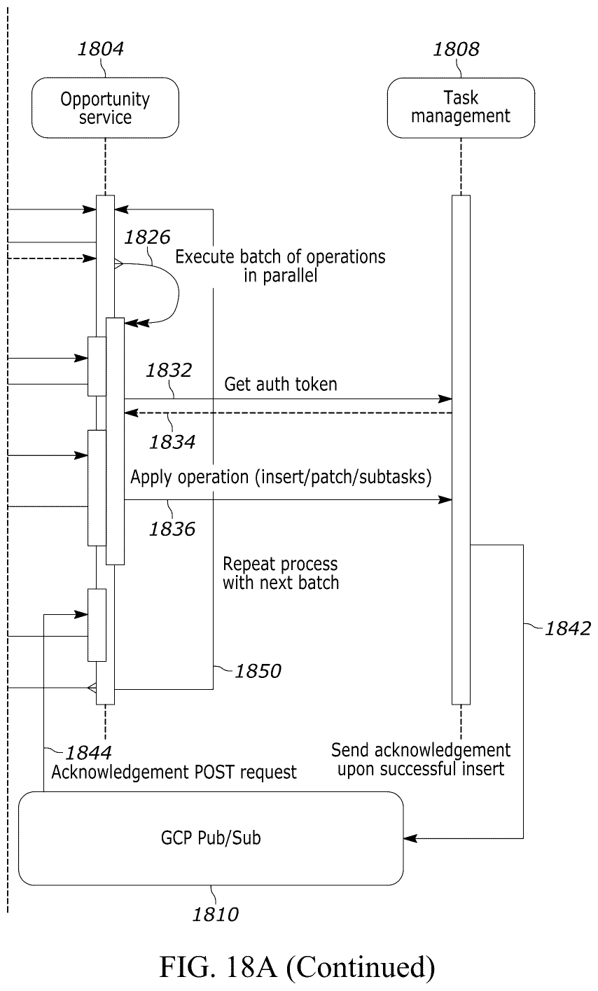

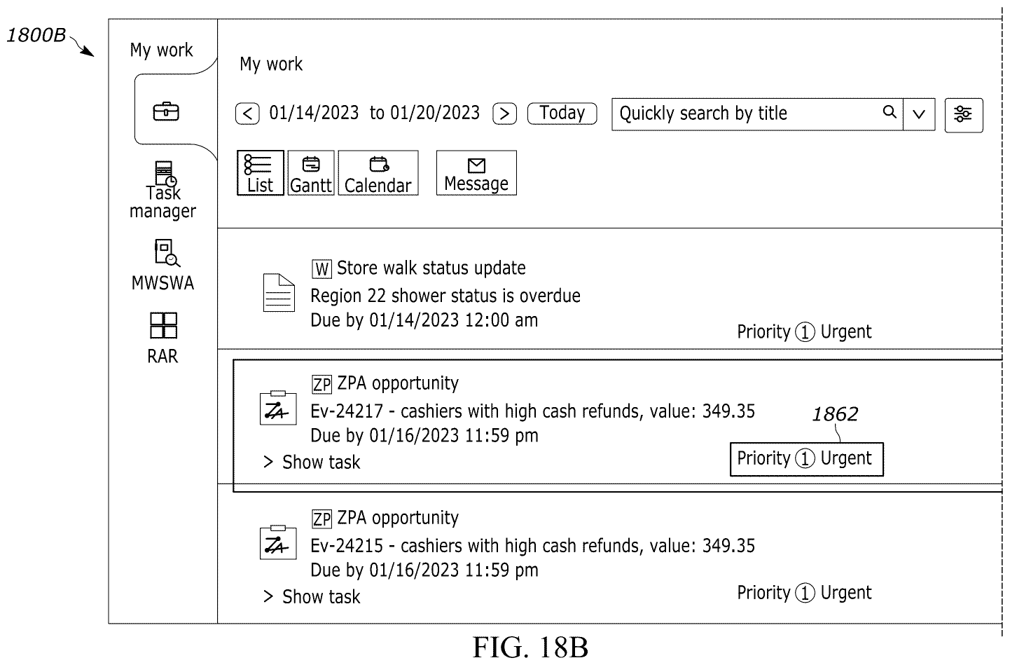

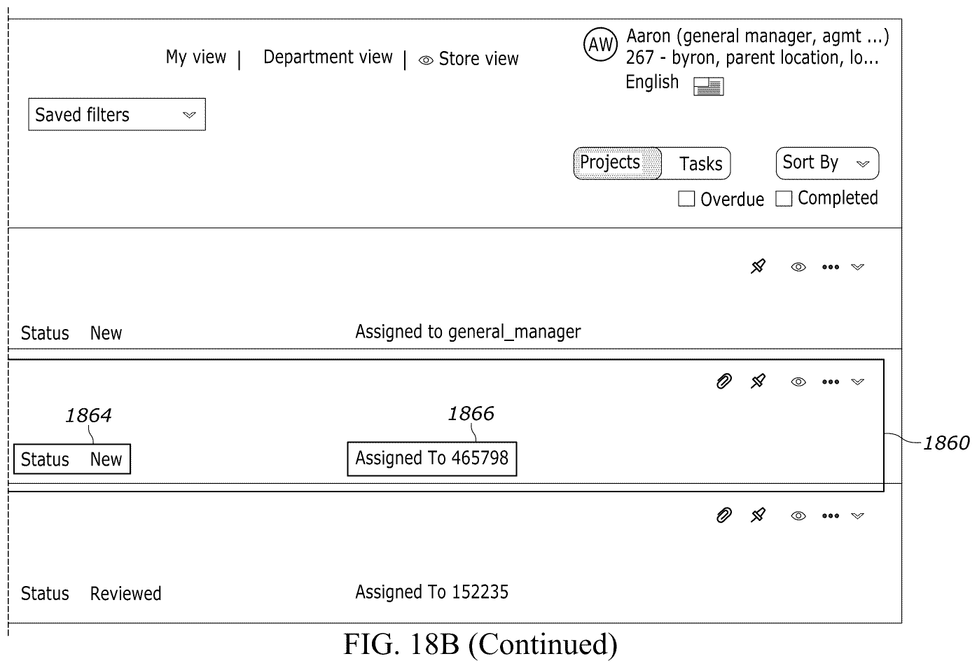

FIGS. 18A-18B depict communicating prescriptive actions to an external task management device.

FIG. 18A depicts a sequence diagram for a sequence 1800A associated with communicating prescriptive actions (e.g., opportunity), as may be executed by instructions stored in the memory 1926 of the server 1904, the task management system 1910, and one or more cloud APIs 1914, as shown in FIG. 19. The sequence 1800A includes a timeline of events affecting a scheduler 1802, an opportunity service 1804, an operations queue 1806, task management 1808, and a messaging service 1810. The scheduler 1802 may schedule jobs and may be a service API such as GCP Cloud Scheduler. The opportunity service 1804 may be a service that identifies prescriptive actions for correcting the anomaly and may be part of the analytics service 1928 of FIG. 19. The operations queue 1806 may be a database server, such as a SQL server, that stores and retrieves operations, such as a database 1906 of FIG. 19. Task management 1808 may be an external task management system that displays tasks to various users, such as the task management system 1910 of FIG. 19. The messaging service 1810 may be a messaging service API such as GCP Pub/Sub that facilitates communications from various services and allows for asynchronous communications.

As shown in FIG. 18A, the scheduler 1802 may transmit a signal to the opportunity service 1804 at step 1820 to initiate batch processing of operations. The scheduler 1802 may periodically initiate such processing.

The opportunity service 1804 may query the operations queue 1806 at step 1822 for a batch of operations. The operations may be sorted by priority. At step 1824, the opportunity service 1804 may receive the requested batch of operations from operations queue 1806.

At step 1826, the opportunity service 1804 may execute the batch of operations to identify opportunities and/or changes and/or updates in opportunities, i.e., identify prescriptive actions and/or changes and/or updates to prescriptive actions to transmit to the external task management 1808. Such prescriptive actions may be identified based on a set of instructions for anomaly detection.

At step 1828, the messaging service 1810 may generate a post request to create the opportunity. At step 1830, the opportunity service 1804 may transmit an operation associated with the opportunity to the operations queue 1806 to be added to the operations queue 1806.

At step 1832, the opportunity service 1804 may transmit a request 1832 for an authorization token from task management 1808 so that an opportunity may be added to and/or changed in the external task management system 1808. At step 1834, the opportunity service 1804 may receive the authorization token.

At step 1836, the opportunity service 1804 may transmit the opportunity to task management 1808 in a post request. The opportunity and the authorization token may be included in the request.

At step 1838, the messaging service 1810 may generate a patch request to change and/or update an existing opportunity. At step 1840, the opportunity service 1804 may transmit an operation associated with the opportunity to the operations queue 1806 to change and/or update the existing opportunity in the operations queue 1806. The opportunity service 1804 may transmit the change and/or update to the existing opportunity at step 1836. The request to transmit the change and/or update to the existing opportunity may include the authorization token received from task management 1808 at step 1834.

At step 1842, task management 1808 may transmit an acknowledgement that an opportunity has been successfully added to, changed, or updated in task management 1808. The acknowledgement may be sent to the messaging service 1810. At a step 1844, the messaging service 1810 may generate and transmit a post request of the acknowledgement to the opportunity service 1804.

At step 1846, the opportunity service 1804 may add any corresponding subtask operations to the operations queue 1802 after receiving the acknowledgement from the messaging service 1810.

At step 1848, the opportunity service 1804 may remove the batch of operations from the queue. At a step 1850, the opportunity service 1804 may repeat the process with a subsequent batch of operations.

FIG. 18B depicts an example user interface of an external task management system, such as task management 1808 in FIG. 18A. As shown in FIG. 18B, a prescriptive action 1860, i.e. an opportunity, may be received by the task management service and displayed to the user in the user interface 1800B. The prescriptive action 1860 may be selected as specified in the set of instructions for anomaly detection. In some embodiments, a prescriptive action may be transmitted to an external task management user interface without any information about the anomalous item, e.g., a reason for the anomaly and/or prescriptive action. For example, a user of the task management interface may see only the action to take to correct the anomaly, but not why the item is anomalous. In some embodiments, information about an anomalous item may be transmitted to the task management interface such that a user of the task management interface may be able to view the information regarding the anomalous item. In some embodiments, the amount of information about an anomalous item transmitted to the task management interface depends on a security level and/or responsibility level. In some embodiments, the prescriptive action may include a priority level 1862, a status 1864, and user identifier 1866 of the user to whom the prescriptive action is assigned.

FIG. 19 is a block diagram of an example system that may be used to implement the various systems and methods for identifying a source of an anomaly. The system of FIG. 19 may include one or more store computing devices 1902, a server 1904, one or more databases 1906, one or more user devices 1908, and an external task management system 1910. The computing system may further include one or more cloud application programming interfaces (APIs) 1914. The store computing devices 1902, the server 1904, the databases 1906, and the user devices 1908 may be communicatively coupled via a network 1912.

The store computing devices 1902 may be various computing devices located at a store. The store computing devices 1902 may be devices such as smart phones, tablets, desktop computers, cash registers, or other devices that are used in the operation of the store. Each of the user devices 1908 may include a processor and a memory (not depicted) including instructions that, when executed, cause the store computing devices 1902 to gather data associated with the operation of the store. The store computing devices may transmit collected data to other components of the system 1900, such as the server 1904 or database 1906.

The server 1904 of FIG. 19 may include one or more processors 1920, one or more network interfaces 1924, and one or more memories 1926. The one or more memories 1926 may have stored thereon an anomaly detector/analytics service module 1928 (e.g., one or more sets of instructions for detecting anomalies from data gathered by the store computing devices 1902) and a pattern engine 1932 (e.g., one or more sets of instructions for generating a set of instructions for anomaly detection). In some aspects, the memories 1926 may include additional modules and/or services for receiving and processing data from one or more other components of the system 1900 such as the one or more cloud APIs 1914, one or more store computing devices 1902, one or more user devices 1908, the databases 1906, and/or the external task management system 1910.

The processors 1920 of the illustrated example may be implemented using hardware, and may include a semiconductor based (e.g., silicon-based) device. The processors 1920 may be, for example, one or more programmable microprocessors, controllers, digital signal processors (DSP), graphics processing units (GPU) and/or any suitable type of programmable processor capable of executing instructions to, for example, implement operations of the example methods described herein. Additionally or alternatively, the processors 920 may be a field programmable gate array (FPGA), an application specific integrated circuit (ASIC,) etc. that implements operations of the example methods described herein without executing instructions.

The example server 1904 of FIG. 19 includes one or more communication interfaces such as, for example, the one or more network interfaces 1924. The communication interface(s) 1924 enable the server 1904 of FIG. 19 to communicate with, for example, another device, system, etc. (e.g. store computing devices 1902, database 1906, user device 1908), any other database, and/or any other machine.

The example server 1904 of FIG. 19 includes the network interface(s) 1924 to enable communication with other machines via, for example, one or more networks such as the network 1912. The example network interfaces 1924 include any suitable type of communication interface(s) (e.g., wired and/or wireless interfaces) configured to operate in accordance with any suitable communication protocol(s). Example network interfaces 1924 include a TCP/IP interface, a WiFi™ transceiver (e.g., according to the IEEE 802.11x family of standards), an Ethernet transceiver, a cellular transceiver, a satellite transceiver, an asynchronous transfer mode (ATM) transceiver, a digital subscriber line (DSL) modem, a coaxial cable modem, a dialup modem, or any other suitable interface based on any other suitable communication protocols or standards.

The memories 1926 may include volatile and/or non-volatile storage media. For example, the memories 1926 may include one or more random access memories, one or more read-only memories, one or more cache memories, one or more hard disk drives, one or more solid-state drives, one or more non-volatile memory express, one or more optical drives, one or more universal serial bus flash drives, one or more external hard drives, one or more network-attached storage devices, one or more cloud storage instances, one or more tape drives, etc.

As noted, the memories 1926 may have stored thereon an anomaly detection/analytics service module 1928, for example, as one or more sets of computer-executable instructions for implementing methods for identifying one or more anomalies. The anomaly detection/analytics service module 1928 may be implemented using any suitable computer programming language(s) (e.g., Python, JavaScript, C, C++, Rust, C#, Swift, Java, Go, LISP, Ruby, Fortran, etc.). The anomaly detection/analytics service module 1928 may include one or more submodules, including a machine learning module 1930.

The machine learning module 1930 may include instructions for detecting anomalies in a dataset created from data collected from store computing devices 1902. In some implementations, the machine learning module 1930 may include instructions for preprocessing the dataset in preparation for input to a machine learning model. The machine learning module 1930 may include further instructions for the training and operation of a machine learning model. For example, as discussed above, the present techniques may include training an autoencoder in real-time and using the autoencoder to detect anomalies on a dataset created from data collected from store computing devices 1902.

The memories 1926 may have stored thereon a pattern engine 1932, for example, as one or more sets of computer-executable instructions for generating and executing a set of instructions for anomaly detection on an updated dataset, i.e., a pattern. The pattern engine 1932 may be implemented using any suitable computer programming language(s) (e.g., Python, JavaScript, C, C++, Rust, C#, Swift, Java, Go, LISP, Ruby, Fortran, etc.). The pattern engine may communicate with the anomaly detection/analytics service module 1928 to instruct the anomaly detection/analytics service module 1928 to detect anomalies on a dataset.

The memories 1926 may have stored thereon a user interface generation module 1934, for example, as one or more sets of computer-executable instructions for implementing methods for identifying one or more anomalies. The UI generation module 1934 may be implemented using any suitable computer programming language(s) (e.g., Python, JavaScript, C, C++, Rust, C#, Swift, Java, Go, LISP, Ruby, Fortran, etc.). The UI generation module 1934 may be used to render a user interface in which a user may create and link queries.

In some examples, the server 1904 also includes, or is otherwise communicatively coupled to, one or more databases 1906 or other data storage mechanisms (one or more of a HDD, optical storage drive, solid state storage device, CD, CD-ROM, DVD, Blu-ray disk, RAID, data storage bank, etc.). In some examples, the databases 1906 may be cloud databases that are accessible via the cloud APIs 1914.

The server 1904 may communicate with the user devices 1908. The user devices may be devices such as smart phones, tablets, desktop computers, etc. The user devices may be used to interact with the server 1904. Each of the user devices 1908 may include a processor and a memory (not depicted) including instructions (e.g., instructions corresponding to an application) that, when executed, cause information received from the server 1904, such as detected anomalous items, to be displayed on the user devices 1908.

In some examples, the server 1904 may communicate with an external task management system 1910 via the network 1912. The external task management system 1910 may include instructions to cause user devices 1908 to display information associated with an anomalous item. The external task management system 1910 may be implemented on another server (not depicted). In some examples, the external task management system 1910 may be a cloud application. The external task management system 1910 may include one or more APIs (not depicted) for enabling one or more other components within the environment 1900 to access functionality of the external task management system 1910, for example, to receive opportunities (i.e., tasks) from other components within the environment 1900.

In some embodiments, the user device 1902 and/or the server 1904 may offload some or all of their respective functionality to the one or more cloud APIs 1914. In aspects, the one or more cloud APIs 1914 may include one or more public clouds, one or more private clouds and/or one or more hybrid clouds. The one or more cloud APIs 1914 may include one or resources provided under one or more service models, such as Infrastructure as a Service (IaaS), Platform as a Service (PaaS), Software as a Service (SaaS), and Function as a Service (FaaS). For example, the one or more cloud APIs 1914 may include one or more cloud computing resources, such as computing instances, electronic databases, operating systems, email resources, etc. The one or more cloud APIs 1914 may include distributed computing resources that enable, for example, communication of tasks between the server 1904, the database 1906, and the task management system 1910. In some aspects, the one or more cloud APIs 1914 may include APIs such as GCP Cloud Scheduler, GCP Pub/Sub, etc.

FIG. 20 depicts an example of validation errors. Validation errors may occur when creating and linking queries in a user interface. Error 2002 depicts an unconnected query error. Queries 2002a-d are all linked together, but query 2002e is not linked to the queries 2002a-d, causing an error. Multiple queries must always be linked in the user interface to be valid.

Error 2004 depicts a circular dependency error. Query 2004a is linked to query 2004b, which is linked to query 2004c. However, query 2004c also links back to error 2004a such that the result of query 2004c is also input into query 2004a (i.e., the query 2004a is based at least in part on the dataset retrieved according to the query 2004c). To be valid, a subsequent query must not link back to a parent query such that the result of the parent query would be based on or depend on the result of the subsequent query.

Error 2006 depicts a multiple final query error. Root query 2006a is linked to queries 2006b and 2006c, which are at the top of the linked query tree (i.e., final queries). A linked query tree may only have one final query (i.e., one top of the tree) to be valid. However, a linked query tree may have more than one root query linked to a final query and still be valid.

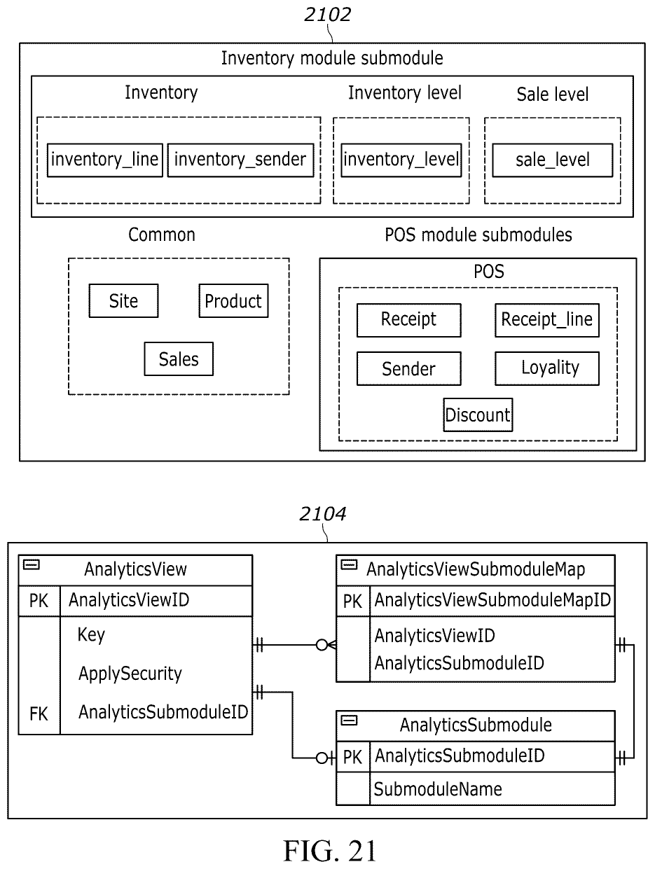

FIG. 21 depicts an example of query validation. A dimension in a first set of data corresponding to a first query must also be included in a second set of data corresponding to a second linked to the first query. For example, a set of point of sale data may include a cashier dimension. A set of RFID data includes a product dimension but does not include a cashier dimension and thus data about the cashier cannot be passed to a query about RFID data (i.e., a point of sale query cannot be linked to an RFID query). However, if the set of point of sale data additionally includes a product dimension, data about the product can be passed to a query about RFID data. Module 2102 shows an example of grouping measures and dimensions by submodule, with common submodules grouped together. Mapping 2104 shows an example of common table expressions (CTE) joined together by common dimensions. Measures and dimensions are grouped by a submodule or a star schema in which they belong. Independent queries are generated for each of groups. The queries are used to define CTEs, and the resulting datasets are joined back together by the common dimensions that exist between the CTEs (e.g., a site or product). This approach shares a lot of the same logic as complex measures, and thus utilizes the same code where applicable.

### Additional Considerations

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their respective entireties, for all purposes. Implementations of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean.” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the implementations herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular implementations and applications have been illustrated and described, it is to be understood that the disclosed implementations are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for anomaly detection, the method comprising:
receiving, via one or more processors, a set of data parameters defining a first query;
retrieving, via the one or more processors, a first dataset corresponding to the set of data parameters from a database;
receiving, via the one or more processors, a second set of data parameters defining a second query linked to the first query;
selecting, via the one or more processors, a predefined filter;
retrieving, via the one or more processors, a second dataset based on the first dataset, the predefined filter, and the second set of data parameters corresponding to the second query linked to the first query;
analyzing, via the one or more processors and using a machine learning model trained in real-time, the second dataset to detect one or more anomalies in the second dataset;
selecting, via the one or more processors, a set of anomaly parameters corresponding to the detected one or more anomalies;
filtering, via the one or more processors, an output of the machine learning model according to the set of anomaly parameters;
generating, via the one or more processors, a set of instructions for identifying one or more anomalous items based on the set of data parameters, the predefined filter, the second set of data parameters, the set of anomaly parameters, and a set of detection pattern parameters;
executing, via the one or more processors, the set of instructions for identifying anomalous items to identify one or more anomalous items in real-time within the second dataset responsive to updates to the second dataset; and
transmitting, via the one or more processors, information about the one or more anomalous items to a user computing device or another computing device.

2. The method of claim 1, wherein the machine learning model is an autoencoder neural network and further comprising training the autoencoder neural network in real-time by providing the autoencoder neural network data corresponding to the one or more anomalies in the second dataset.

3. The method of claim 1, wherein the set of detection pattern parameters include one or more of: (i) a time frame indicating which values to include in a second dataset, (ii) a schedule for further anomaly detection, (iii) one or more prescriptive actions associated with the one or more anomalous items, (iv) a security level associated with the one or more anomalous items, or (v) a responsibility level associated with the one or more anomalous items; and
wherein the anomaly parameters include one or more of: (i) an indication of an anomaly, (ii) an anomaly score, or (iii) a first and second principal component of a principal component analysis.

4. The method of claim 1, wherein the information about the one or more anomalous items includes one or more of (i) an explanation of an anomaly affecting the one or more anomalous items and/or (ii) a prescriptive action to correct the one or more anomalous items, and wherein transmitting the information about the one or more anomalies to the user device or the another computing device includes:
identifying at least one data class associated with the one or more anomalous items;
based on the at least one data class, identifying one or more of a security level or a responsibility level;
identifying, in the information, scheduler data that comprises a prescriptive action to correct the anomalous item and identification of an external task management system to receive the prescription action; and
transmitting the information based on one or more of the security level or the responsibility level.

5. The method of claim 1, further comprising:
updating in real-time the first dataset; and
based on the updating in real-time to the first dataset, updating in real-time the second dataset.

6. The method of claim 1, further comprising:
receiving, by the one or more processors, a third set of data parameters defining a third query, wherein the third query is linked to the first query and the second query; and
retrieving, via the one or more processors, a third dataset based on the first dataset, a predefined filter associated with the third query, the second set of data parameters corresponding to the third query linked to the first query and the second query.

7. The method of claim 1, further comprising:
receiving, by the one or more processors, a fourth set of data parameters defining a fourth query, wherein the fourth query is linked to the second query; and
retrieving, via the one or more processors, a fourth dataset based on the second dataset, a predefined filter associated with the fourth query, the fourth set of data parameters corresponding to the fourth query linked to the second query.

8. The method of claim 1, wherein the second query is linked to the first query through filter rules, and wherein the filter rules depend upon the second query.

9. The method of claim 1, wherein the second query is linked to the first query through filter rules, and wherein the filter rules do not depend on the second query.

10. The method of claim 1, further comprising:
validating the first query and the second query by determining, by the one or more processors, that a data parameter in the set of data parameters corresponding to the first query is included in the second set of data parameters corresponding to the second query.

11. The method of claim 1, further comprising:
validating the second query by determining, by the one or more processors, that the second query is linked to the first query to validate the second query.

12. The method of claim 1, further comprising:
validating the first query and the second query by determining, by the one or more processors, that the first dataset is not based on the second dataset.

13. The method of claim 6, further comprising:
validating the third query by determining, by the one or more processors, that the third query is linked to the second query.

14. The method of claim 1, wherein the predefined filters include at least one of a behavior between queries and a timing parameter.

15. A system for anomaly detection, the system comprising:
one or more processors, and
one or more memories having stored thereon computer-executable instructions that, when executed by the one or more processors, cause the system to:
receive a set of data parameters defining a first query;
retrieve a first dataset corresponding to the set of data parameters from a database;
receive a second set of data parameters defining a second query linked to the first query;
select a predefined filter;
retrieve a second dataset based on the first dataset, the predefined filter, and the second set of data parameters corresponding to the second query linked to the first query;
analyze, using a machine learning model trained in real-time, the second dataset to detect one or more anomalies in the dataset;
select a set of anomaly parameters corresponding to the detected one or more anomalies;
filter an output of the machine learning model according to the set of anomaly parameters;
generate a set of instructions for identifying one or more anomalous items based on the set of data parameters, the predefined filter, the second set of data parameters, the set of anomaly parameters, and a set of detection pattern parameters;
execute the set of instructions for identifying anomalous items to identify one or more anomalous items in real-time within the second dataset responsive to updates to the second dataset; and
transmit information about the one or more anomalous items to a user computing device or another computing device.

16. The system of claim 15, wherein the second query is linked to the first query through filter rules.

17. The system of claim 15, the one or more memories having stored thereon computer-executable instructions that, when executed by the one or more processors, further cause the computing system to:
validate the first query and the second query by determining that a data parameter in the set of data parameters corresponding to the first query is included in the second set of data parameters corresponding to the second query.

18. The system of claim 15, the one or more memories having stored thereon computer-executable instructions that, when executed by the one or more processors, further cause the computing system to:
validate the second query by determining that the second query is linked to the first query.

19. The system of claim 15, the one or more memories having stored thereon computer-executable instructions that, when executed by the one or more processors, further cause the computing system to:
validate the first query and the second query by determining that the first dataset is not based on the second dataset.

20. The system of claim 15, the one or more memories having stored thereon computer-executable instructions that, when executed by the one or more processors, further cause the computing system to:
receive a third set of data parameters defining a third query, wherein the third query is linked to the first query and the second query;
retrieve a third dataset based on the first dataset, a predefined filter associated with the third query, the second set of data parameters corresponding to the third query linked to the first query and the second query; and
validate the third query by determining that the third query is linked to the second query.
